(19) United States
(12) Patent Application Publication
(10) Pub. No.: US 2020/0026305 A1
(43) Pub. Date: Jan. 23, 2020

(54) HAUL VEHICLE CONTROL SYSTEM AND HAUL VEHICLE MANAGEMENT METHOD

(71) Applicants: Komatsu Ltd., Tokyo (JP); National University Corporation YOKOHAMA National University, Yokohama-shi (JP)

(72) Inventors: Takashi Maekawa, Yokohama-shi (JP); Taketoshi Suzuki, Yokohama-shi (JP); Riku Usami, Yokohama-shi (JP); Yuji Kobashi, Tokyo (JP); Koji Takeda, Tokyo (JP); Tomikazu Tanuki, Tokyo (JP)

(21) Appl. No.: 16/493,047

(22) PCT Filed: Jun. 28, 2018
(86) PCT No.: PCT/JP2018/024739

§ 371 Date: Sep. 11, 2019

(30) Foreign Application Priority Data
Aug. 10, 2017 (JP) 2017-156208

(51) Int. Cl. G05D 1/02

(52) U.S. Cl. CPC G05D 1/0274; G05D 1/0217; G05D 2201/021; G05D 2201/0202; G05D 1/0289

(57) ABSTRACT

A haul vehicle control system includes a reference line creating unit configured to create, on the basis of a boundary curve of a running area in a work site where a haul vehicle runs, a reference line set in the running area, and a running course creating unit configured to create a running course for the haul vehicle which is set in the running area on the basis of the reference line.

### FIELD

The present invention relates to a haul vehicle control system and a haul vehicle management method.

### BACKGROUND

In a wide work site such as a mine, unmanned haul vehicles are used for haulage work. In a work site, running courses are set for haul vehicles. Haul vehicles are controlled to run along running courses. As a method of setting running courses, there is known a method of setting running courses on the basis of the topographic features of a work site. In the method of setting running courses on the basis of the topographic features of a work site, a survey vehicle as a manned vehicle runs along topographic boundary lines such as banks and cliffs to set a survey line indicating the boundary curve of a running area for haul vehicles on the basis of the running locus of the survey vehicle. After the survey line is set, a running course is set at a position offset from the survey line to the running area by a specified amount. A running area for haul vehicles is an area where the haul vehicles are permitted to run.

### CITATION LIST

### Patent Literature

Patent Literature 1: Japanese Laid-open Patent Publication No. 2012-118694

### SUMMARY

### Technical Problem

When a topographic boundary line includes undulations, the running locus of the survey vehicle running along the boundary line meanders. In addition, the running locus of the survey vehicle may meander due to a driving environment for the survey vehicle, the skill of a driver, and the like. When the running course of the survey vehicle meanders, a survey line set on the basis of the running locus of the survey vehicle and a running course set on the basis of the survey line also meander. If a running course unnecessarily meanders, for example, the running distance of a haul vehicle may increase and the running velocity of the haul vehicle running along the running course may not be sufficiently increased. This may lead to a decrease in the work efficiency of the haul vehicle and a decrease in productivity in a work site.

When a skilled driver drives a survey vehicle, it is highly possible to suppress the meandering of the running locus of the survey vehicle and set a survey line that can suppress a decrease in the work efficiency of a haul vehicle. In contrast to this, when an unskilled driver drives the survey vehicle, the running locus of the survey vehicle is likely to meander. Accordingly, there is a demand for a technique capable of creating a running course that is robust against man-made influences.

An aspect of the present invention has an object to suppress a decrease in productivity in a work site.

### Solution to Problem

According to an aspect of the present invention, a haul vehicle control system comprises: a reference line creating unit configured to create, based on a boundary curve of a running area in a work site where a haul vehicle is configured to run, a reference line set in the running area; and a running course creating unit configured to create a running course for the haul vehicle which is set in the running area, based on the reference line.

### Advantageous Effects of Invention

According to an aspect of the present invention, a decrease in productivity in a work site can be suppressed.

### BRIEF DESCRIPTION OF DRAWINGS

FIG. 1 is a view schematically illustrating an example of a work site where a haul vehicle control system according to an embodiment and haul vehicles operate.

FIG. 2 is a schematic view for explaining an example of the boundary curve of a running area, a reference line, and a running course according to this embodiment.

FIG. 3 is a perspective view of a haul vehicle according to this embodiment when viewed from behind.

FIG. 4 is a view for explaining the relationship between a haul vehicle and a running course according to this embodiment.

FIG. 5 is a functional block diagram illustrating an example of a haul vehicle control system according to this embodiment.

FIG. 6 is a schematic view for explaining a start point and an end point according to this embodiment.

FIG. 7 is a flowchart illustrating an example of a running course creating method according to this embodiment.

FIG. 8 is a flowchart illustrating an example of a reference line creating method according to this embodiment.

FIG. 9 is a schematic view for explaining the reference line creating method according to this embodiment.

FIG. 10 is a schematic view for explaining the reference line creating method according to this embodiment.

FIG. 11 is a schematic view for explaining the reference line creating method according to this embodiment.

FIG. 12 is a schematic view for explaining the reference line creating method according to this embodiment.

FIG. 13 is a schematic view for explaining the reference line creating method according to this embodiment.

FIG. 14 is a schematic view for explaining the reference line creating method according to this embodiment.

FIG. 15 is a schematic view for explaining the reference line creating method according to this embodiment.

FIG. 16 is a schematic view for explaining the reference line creating method according to this embodiment.

FIG. 17 is a schematic view for explaining the reference line creating method according to this embodiment.

FIG. 18 is a schematic view for explaining a reference line creating method and a running course creating method according to this embodiment.

FIG. 19 is a flowchart illustrating an example of a running course creating method according to this embodiment.

FIG. 20 is a schematic view for explaining the running course creating method according to this embodiment.

FIG. 21 is a schematic view for explaining the running course creating method according to this embodiment.

FIG. 22 is a schematic view for explaining the running course creating method according to this embodiment.

FIG. 23 is a schematic view for explaining the running course creating method according to this embodiment.

FIG. 24 is a schematic view for explaining the running course creating method according to this embodiment.

FIG. 25 is a schematic view for explaining the running course creating method according to this embodiment.

FIG. 26 is a schematic view illustrating an example of creating a running course on the basis of the boundary curve of a running area.

### DESCRIPTION OF EMBODIMENTS

An embodiment of the present invention will be described below with reference to the accompanying drawings. However, the present invention is not limited to this. The constituent elements of the embodiment to be described below can be combined as needed. In addition, some of the constituent elements are not sometimes used.

[Work Site]

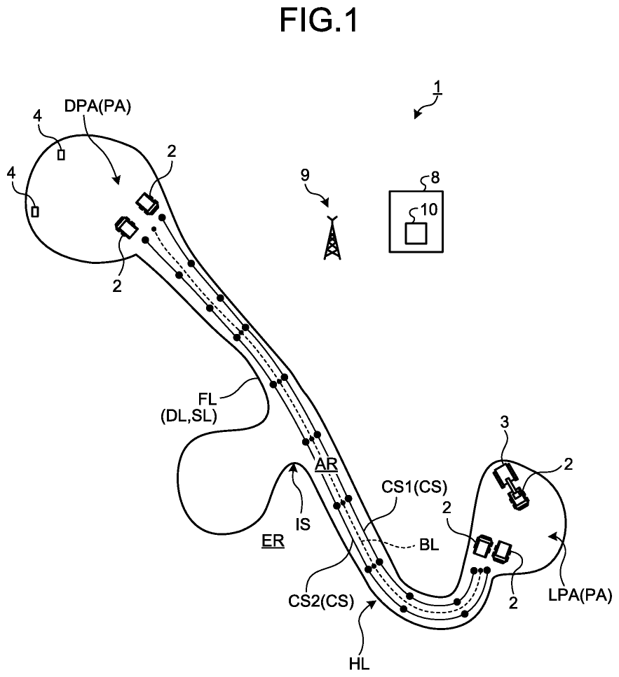

FIG. 1 is a view schematically illustrating an example of a work site where a control system 1 for a haul vehicle 2 and the haul vehicle 2 according to this embodiment operate will be described. In the embodiment, the work site is a mine. The haul vehicle 2 is a dump truck that runs in the work site and can haul cargo. The mine is a site of mineral excavation or a corresponding office. The cargo hauled by the haul vehicle 2 is, for example, the ore or soil excavated from the mine.

The haul vehicle 2 runs on at least part of a mining work site PA and a running road HL leading to the work site PA. The work site PA includes at least one of a load site LPA and an unload site DPA. The running road HL includes an intersection point IS.

The load site LPA is an area where loading work is executed to load cargo on the haul vehicle 2. In the load site LPA, loading equipment 3 like a hydraulic shovel operates. The unload site DPA is an area where unloading work is executed to unload cargo from the haul vehicle 2. The unload site DPA is provided with, for example, a crushing machine 4.

The control system 1 including a management apparatus 10 and a communication system 9. The management apparatus 10 includes a computer system and is installed in a control facility 8 for the mine. The communication system 9 executes data communication and signal communication between the management apparatus 10 and the haul vehicle 2. The management apparatus 10 and the haul vehicle 2 perform wireless communication via the communication system 9.

The haul vehicle 2 is an unmanned dump truck that runs in an unmanned manner without operation by a driver. The haul vehicle 2 runs along a running course CS set on the running road HL and the work site PA on the basis of control signals from the management apparatus 10.

A running area AR where the haul vehicle 2 can run is set in the work site. The running area AR is an area where the haul vehicle 2 is permitted to run. The running area AR includes the running road HL and the work site PA. The running course CS is set in the running area AR. In addition, a forbidden area ER where the haul vehicle 2 is forbidden to run is set in the work site.

The running area AR is defined by a boundary curve FL of the running area AR. The boundary curve FL is a partition line for partitioning the running area AR and the forbidden area ER from each other. The running area AR is an area on one side of the boundary curve FL. The forbidden area ER is an area on the other side of the boundary curve FL. When, for example, the boundary curve FL surrounds the running area AR, the running area AR is an area surrounded by the boundary curve FL. Note that the boundary curve FL need not surround the running area AR. The boundary curve FL may linearly extend to partition the running area AR and the forbidden area ER from each other.

A reference line BL is set in the running area AR on the basis of the boundary curve FL of the running area AR. The running course CS is set in the running area AR on the basis of the reference line BL. The running courses CS are set on both sides of the reference line BL. The running courses CS include a running course CS1 (first running course) set one side of the reference line BL and a running course CS2 (second running course) set on the other side of the reference line BL. The haul vehicle 2 runs on the running road HL in accordance with the running course CS. For example, the haul vehicle 2 runs in the unload site DPA from the load site LPA along the running course CS1, and runs in the load site LPA from the unload site DPA along the running course CS2.

The position of the haul vehicle 2 is detected by using a global navigation satellite system (GNSS). The global navigation satellite system includes a global positioning system (GPS). The global navigation satellite system detects the absolute position of the haul vehicle 2 defined by coordinate data of a latitude, a longitude, and an altitude. The global navigation satellite system detects the position of the haul vehicle 2 defined in a global coordinate system. The global coordinate system is a coordinate system fixed to the globe.

In this embodiment, various types of processes are executed on the basis of positions in a local coordinate system with reference to an origin set in the mine. The local coordinate system is a coordinate system with reference to an arbitrarily set origin and coordinate axes. Positions in the global coordinate system and the local coordinate system can be converted by using conversion parameters.

[Boundary Curve, Reference Line, and Running Course]

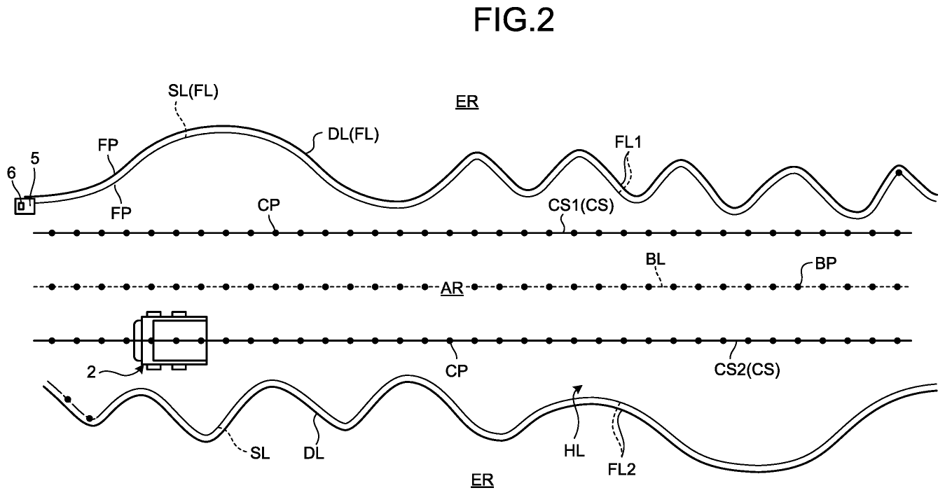

FIG. 2 is a schematic view for explaining an example of the boundary curve FL of the running area AR, the reference line BL, and the running course CS according to this embodiment. FIG. 2 illustrates an example of the reference line BL and the running course CS set on the basis of the boundary curve FL of the running road HL in the running area AR.

As illustrated in FIG. 2, the boundary curve FL includes an aggregate of boundary curve points FP set at intervals. The intervals between the boundary curve points FP may be equal or different. The boundary curve FL is defined by a locus passing through the plurality of boundary curve points FP. The positions of the plurality of boundary curve points FP in the local coordinate system are derived. The position data of the boundary curve FL is defined in the local coordinate system.

The boundary curve FL of the running area AR includes at least one of a boundary line DL of the topographic shape of the work site, the survey line SL set on the basis of the running locus of a survey vehicle 5 that has run along the boundary line DL, the measurement data of the topographic shape measured by a flight vehicle that has flied along the boundary line DL, and the design data of the boundary line DL. That is, the boundary curve FL of the running area AR may be defined by the boundary line DL of the topographic shape, the survey line SL, the measurement data, or the design data.

The boundary line DL of a topographic shape is a feature portion that can partition a work site such as a bank or cliff. When a work site is designed by using a design technique such as a computer aided design (CAD), the boundary line DL of a topographic shape may be derived from the design data of the work site. The design data of the work site designed on the basis of the CAD includes three-dimensional topographic data. The three-dimensional topographic data includes the position data of the boundary line DL and ground gradient data. The boundary line DL is defined by the plurality of boundary curve points FP. The position data of the boundary curve points FP in the global coordinate system is known data. In this embodiment, the position data of the boundary curve points FP defined in the global coordinate system is converted into the position data of the boundary curve points FP defined in the local coordinate system. The position data of the boundary line DL is defined in the local coordinate system. Note that the boundary line DL of the topographic shape may be derived by actually surveying the topographic shape of the work site. The boundary line DL of the topographic shape may be derived from an aerial photo of the work site. The boundary line DL of the topographic shape may be derived on the basis of the measurement data obtained by a measurement device that is mounted in a flight vehicle capable of flying over the work site and can measure the topographic shape of the work site. The flight vehicle may be a drone. The measurement device mounted in the flight vehicle may be a three-dimensional shape measurement device such as an imaging device or laser range finder.

The survey line SL is an imaginary line that is derived by using the survey vehicle 5 and partitions the running area AR and the forbidden area ER from each other. The survey vehicle 5 is a manned vehicle that runs on the basis of the driving operation of a driver driving on the survey vehicle 5. In general, the outer shape of the survey vehicle 5 is smaller than that of the haul vehicle 2. The position of the running survey vehicle 5 is detected by using the global navigation satellite system (GNSS). A position detector 6 that detects the position of the survey vehicle 5 in the global coordinate system is mounted in the survey vehicle 5. The position detector 6 includes a GNSS antenna that receives a GNSS signal from a GNSS satellite, a GNSS computing device that calculates the absolute position of the survey vehicle 5 on the basis of the GNSS signal received by the GNSS antenna, and a local coordinate converter that converts a position in the global coordinate system into a position in the local coordinate system. The survey vehicle 5 runs along the boundary line DL of a topographic shape such as a bank or cliff while detecting the absolute position of the survey vehicle 5 by using the position detector 6. The survey line SL is set on the basis of the running locus of the survey vehicle 5. The survey line SL is defined by the plurality of boundary curve points FP. The position detector 6 mounted in the survey vehicle 5 detects the positions of the boundary curve points FP in the global coordinate system. The position data of the survey line SL is defined in the local coordinate system.

On the running road HL, the boundary curves FL include a boundary curve FL1 (first boundary curve) existing on one side of the running road HL in the widthwise direction, and a boundary curve FL2 (second boundary curve) existing on the other side. The boundary curve FL1 on one side of the running road HL in the widthwise direction faces the boundary curve FL2 on the other side. The running road HL exists between the boundary curve FL1 on one side and the boundary curve FL2 on the other side.

The reference line BL is an imaginary line set for generating the running course CS. The reference line BL is created on the basis of the boundary curve FL. The reference line BL includes the aggregate of reference points BP set at intervals. The intervals between the reference points BP may be equal or different. The reference line BL is defined by a locus passing through the plurality of reference points BP. The position of each of the plurality of reference points BP in the local coordinate system is derived. The position data of the reference line BL is defined in the local coordinate system.

On the running road HL, the reference line BL is set in an almost middle portion in the widthwise direction of the running road HL. Note that the reference line BL may be set in a portion other than the middle portion in the widthwise direction of the running road HL. For example, the reference line BL may be set in an end portion of the running road HL in the widthwise direction. In addition, the reference line BL is set in the work site PA in the running area AR.

The reference line BL is created almost parallel to the target running direction of the haul vehicle 2. For example, on the running road HL, the reference line BL is set so as to extend along the running road HL. The reference line BL is set so as to connect the start point and the end point of the haul vehicle 2 running on the running road HL. As will be described later, a start point as one end portion of the reference line BL is defined between an entrance Mi and an exit Mo of the work site PA as a departure place. An end point as the other end portion of the reference line BL is defined between an entrance Mi and an exit Mo of the work site PA as an arrival place.

The running course CS includes an imaginary line indicating the target running route of the haul vehicle 2. The running course CS is created on the basis of the reference line BL. The running courses CS are set on both sides of the reference line BL. The running course CS is set almost parallel to the reference line BL. The running course CS is defined by a locus passing through a plurality of course points CP. The position data of the running course CS is defined in the local coordinate system.

The running course CS1 (first running course) is set between the reference line BL and the boundary curve FL1 (first boundary curve) on one side of the running road HL in the widthwise direction on the running road HL. The running course CS2 (second running course) is set between the reference line BL and the boundary curve FL2 (second boundary curve) on the other side of the running road HL in the widthwise direction on the running road HL.

[Haul Vehicle]

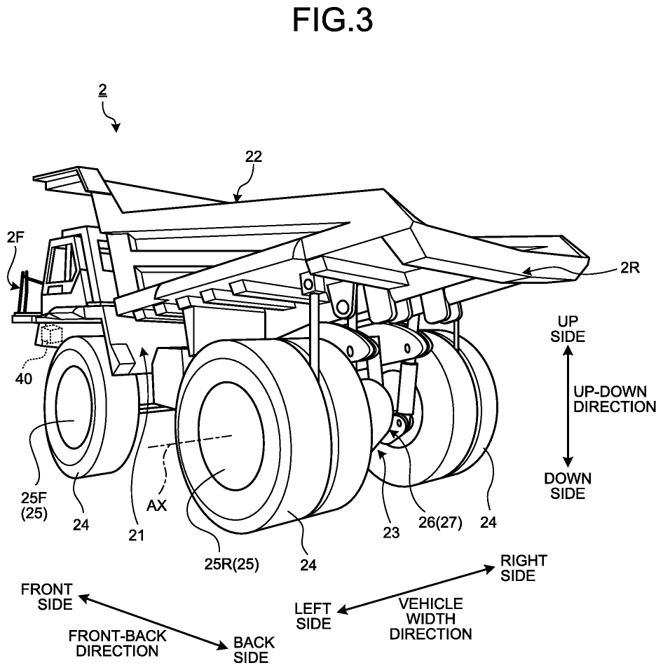

FIG. 3 is a perspective view illustrating the haul vehicle 2 according to this embodiment when viewed from behind. As illustrated in FIG. 3, the haul vehicle 2 includes a vehicle frame 21, a dump body 22 supported on the vehicle frame 21, a running device 23 that runs while supporting the vehicle frame 21, and a controller 40.

The running device 23 includes wheels 25 provided tires 24. The wheels 25 include front wheels 25F and rear wheels 25R. The front wheels 25F are steered by a steering device 33. The rear wheels 25R are not steered. The wheels 25 each rotate about a rotation axis AX.

In the following description, a direction parallel to the rotation axis AX of each rear wheel 25R will be referred to as a vehicle width direction as needed, the traveling direction of the haul vehicle 2 will be referred to as a front-back direction as needed, and a direction orthogonal to the vehicle direction and the front-back direction will be referred to as an up-down direction as needed.

One side in the front-back direction corresponds to the front side, and the reverse direction relative to the front side corresponds to the back side. One side in the vehicle width direction corresponds to the right side, and the reverse direction relative to the right side corresponds to the left side. One side in the up-down direction corresponds to the up side, and the reverse direction relative to the up side corresponds to the down side. The front wheels 25F are arranged in front of the rear wheels 25R. The front wheels 25F are arranged on both sides in the vehicle width direction. The rear wheels 25R are arranged on both sides in the vehicle width direction. The dump body 22 is disposed above the vehicle frame 21.

The vehicle frame 21 supports a driving device 31 that generates a driving force for driving the running device 23. The dump body 22 is a member on which cargo is loaded.

The running device 23 includes rear axles 26 for transmitting the driving force generated by the driving device 31 to the rear wheels 25R. The rear axles 26 include an axle shaft 27 supporting the rear wheels 25R. The rear axles 26 transmit the driving force generated by the driving device 31 to the rear wheels 25R. The rear wheels 25R rotate about the rotation axis AX with the driving force supplied from the rear axles 26. This causes the running device 23 to run.

The haul vehicle 2 can run forward and backward. To run forward is to run while a front part 2F of the haul vehicle 2 faces in the traveling direction. To run backward is to run while a front part 2R of the haul vehicle 2 faces in the traveling direction.

The controller 40 controls the haul vehicle 2. The controller 40 can control the haul vehicle 2 on the basis of the control signal transmitted from the management apparatus 10.

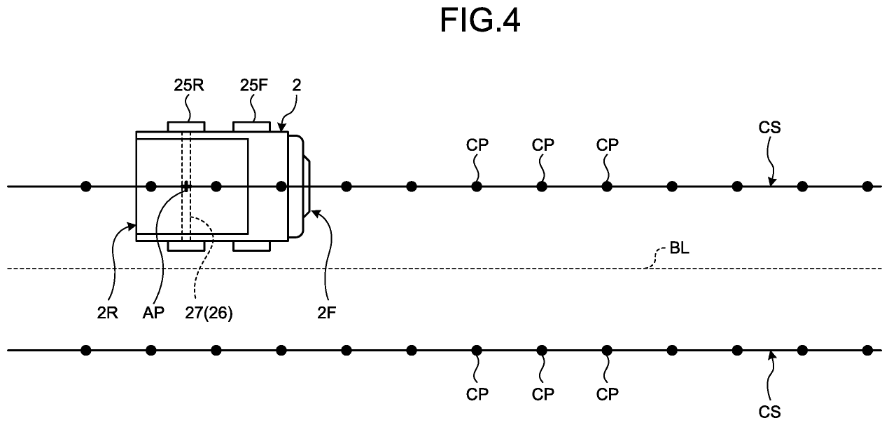

FIG. 4 is a view for explaining the relationship between the haul vehicle 2 and the running course CS according to this embodiment. The running course CS includes the aggregate of the course points CP set at intervals. The intervals between the course points CP may be equal or different. The plurality of course points CP define the running course CS of the haul vehicle 2. The running course CS indicating the target running route of the haul vehicle 2 is defined by a locus passing through the plurality of course points CP or a locus passing through near the plurality of course points CP. The running course CS is set to be linear. Being linear is a concept including a curved shape.

The haul vehicle 2 runs in the running area AR along the running course CS. The haul vehicle 2 runs in the running area AR with a specific portion AP of the haul vehicle 2 moving along the running course CS. The specific portion AP of the haul vehicle 2 is, for example, a central portion of the axle shaft 27 in the vehicle width direction. Note that the specific portion AP need not be the axle shaft 27.

The positions of the course points CP are defined in the local coordinate system. Target points defining the target positions of the haul vehicle 2 running along the running course CS are defined by segmenting the running course CS that is a curve created on the basis of control points MP (to be described later) and knot vectors.

Each of a plurality of target points includes target position data for the haul vehicle 2, the target running velocity data of the haul vehicle 2 at the position where the target point is set, and the target running direction data of the haul vehicle 2 at the position where the target point is set. The target running velocity of the haul vehicle 2 at the position where each target point is set is defined on the basis of target running velocity data. The target running direction of the haul vehicle 2 at the position where each target point is set is defined on the basis of target running direction data. A running condition including at least one of the running route, running velocity, acceleration, deceleration, running direction, stop position, and start position of the haul vehicle 2 is defined on the basis of the target position data, target running velocity data, and target running direction data defined at each of a plurality of target points. Note that data included in the position of each target point and the target point may be calculated on the basis of the shape of the running course CS or the running condition of the haul vehicle 2.

[Control System]

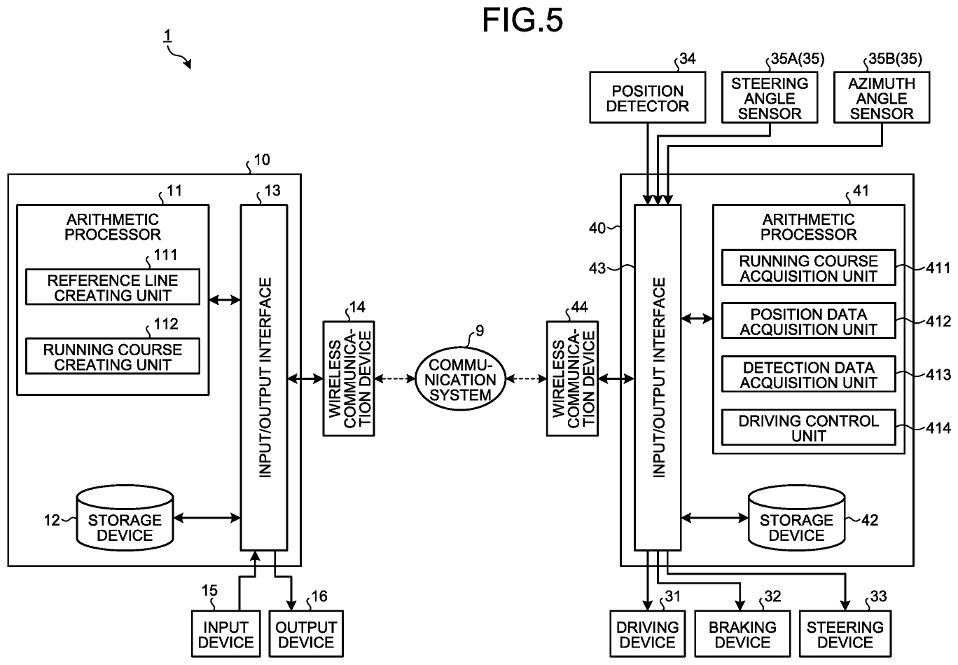

FIG. 5 is a functional block diagram illustrating an example of the control system 1 of the haul vehicle 2 according to this embodiment. The control system 1 of the haul vehicle 2 includes the management apparatus 10 installed in a management facility. The management apparatus 10 performs wireless communication with the controller 40 mounted in the haul vehicle 2 via the communication system 9.

The management apparatus 10 includes a computer system. The management apparatus 10 includes an arithmetic processor 11 including a processor like a central processing unit (CPU), a storage device 12 including a memory like a read only memory (ROM) or random access memory (RAM), and a storage, and an input/output interface 13.

The management apparatus 10 is connected to a wireless communication device 14. The wireless communication device 14 is disposed in the control facility 8. The management apparatus 10 communicates with the haul vehicle 2 via the wireless communication device 14 and the communication system 9.

The management apparatus 10 is connected to an input device 15 and an output device 16. The input device 15 and the output device 16 are installed in the control facility 8. The input device 15 includes, for example, a keyboard, mouse, and touch panel for a computer. The input data created by operating the input device 15 is output to the management apparatus 10. The output device 16 includes a display device. The display device includes a flat panel display like a liquid crystal display (LCD) or organic electroluminescence (EL) display (OELD). The output device 16 operates on the basis of the display data output from the management apparatus 10. Note that the output device 16 may be, for example, a printer.

The arithmetic processor 11 includes a reference line creating unit 111 and a running course creating unit 112.

The reference line creating unit 111 creates the reference line BL set in the running area AR on the basis of the boundary curve FL of the running area AR in the work site where the haul vehicle 2 can run. The reference line creating unit 111 creates the reference line BL on the basis of the boundary curve FL, and sets the created reference line BL in the running area AR. As described above, boundary curve data representing the boundary curve FL is created on the basis of, for example, the boundary line DL derived from the design data of the work site or the survey line SL set by using the survey vehicle 5. For example, when creating the boundary curve FL on the basis of the survey line SL acquired by the survey vehicle 5, the reference line creating unit 111 acquires the survey line SL from the storage device 12. The survey line SL acquired in advance by the survey vehicle 5 is stored in the storage device 12. Accordingly, the reference line creating unit 111 can acquire the survey line SL from the storage device 12. The reference line creating unit 111 acquires boundary curve data representing the boundary curve FL of the running area AR on the basis of the survey line SL, and creates the reference line BL on the basis of the acquired boundary curve data. Note that the boundary curve data may be input to the management apparatus 10 via, for example, the input device 15.

The reference line creating unit 111 generates the reference line BL on the basis of the start point data and the end point data of the haul vehicle 2 running in the running area AR. The start point data of the haul vehicle 2 includes the position data of a start point indicating the departure point of the haul vehicle 2 running in the running area AR. The start point data of the haul vehicle 2 includes the posture data of the haul vehicle 2 which represents the azimuth of the haul vehicle 2 at the start point. The end point data of the haul vehicle 2 includes the position data of an end point indicating the arrival point of the haul vehicle 2 running in the running area AR. The end point data of the haul vehicle 2 includes the posture data of the haul vehicle 2 which represents the azimuth of the haul vehicle 2 at the end point. The azimuth of the haul vehicle 2 corresponds to the direction in which the front part of the haul vehicle 2 faces. The azimuth of the haul vehicle 2 includes an azimuth angle relative to a reference azimuth (for example, north). The azimuth of the haul vehicle 2 is adjusted by the steering operation of the steering device 33.

When, for example, the haul vehicle 2 runs on the running road HL, the haul vehicle 2 on which cargo is loaded in the load site LPA departs from the exit Mo of the load site LPA, and arrives at the entrance Mi of the unload site DPA after running on the running road HL. In the unload site DPA, the cargo is unloaded from the haul vehicle 2. In addition, the haul vehicle 2 from which the cargo is unloaded in the unload site DPA departures from the exit Mo of the unload site DPA and arrives at the entrance Mi of the load site LPA after running on the running road HL. In the load site LPA, cargo is loaded on the haul vehicle 2. In this embodiment, a start point as one end portion of the reference line BL is defined on the basis of the positions of the entrance Mi and the exit Mo of the work site PA as a departure place, and an end point as the other end portion of the reference line BL is defined on the basis of the positions of the entrance Mi and the exit Mo of the work site PA as an arrival place.

The entrance Mi of the work site PA is an entrance from the running road HL to the work site PA and includes an entrance route along which the haul vehicle 2 running on the running road HL enters the work site PA. The exit Mo of the work site PA is an exit from the work site PA to the running road HL and includes an exit route along which the haul vehicle 2 running in the work site PA exits to the running road HL. The entrance Mi and the exit Mo each are defined by, for example, the boundary between the work site PA and the running road HL.

The position data of the entrance Mi and the position data of the exit Mo are stored in the storage device 12. The reference line creating unit 111 acquires the position data of the entrance Mi and the position data of the exit Mo from the storage device 12 and creates the reference line BL. Note that the position data of the entrance Mi and the position data of the exit Mo may be input to the management apparatus 10 via, for example, the input device 15.

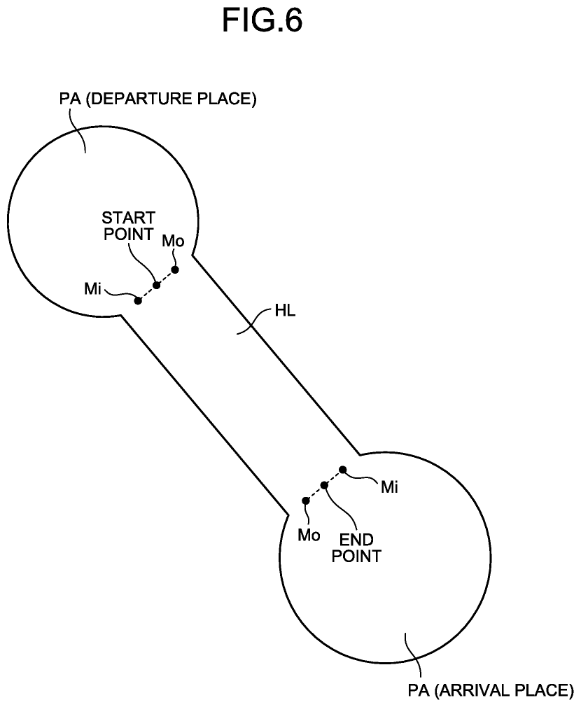

FIG. 6 is a schematic view for explaining a start point and an end point according to this embodiment. As illustrated in FIG. 6, the entrance Mi and the exit Mo are defined on the boundary between the work site PA and the running road HL. When both the entrance Mi and the exit Mo are defined in one work site PA as a departure place of the haul vehicle 2, a start point that is one end portion of the reference line BL is defined at the middle point between the entrance Mi and the exit Mo in the departure place. When both the entrance Mi and the exit Mo are defined in one work site PA that is a departure place of the haul vehicle 2, an end point that is the other end portion of the reference line BL is defined at the middle point between the entrance Mi and the exit Mo in the arrival place. Note that a start point is only required to be defined between the entrance Mi and the exit Mo in the departure place, and may be defined at a position offset from the middle point between the entrance Mi and the exit Mo by a predetermined distance. Likewise, an end point is only required to be defined between the entrance Mi and the exit Mo in the arrival place, and may be defined at a position offset from the middle point between the entrance Mi and the exit Mo by a predetermined distance.

The running course creating unit 112 creates the running course CS of the haul vehicle 2 which is set on the basis of the reference line BL. The running course CS includes an imaginary line set almost parallel to the reference line BL. The running course creating unit 112 sets the running courses CS on both sides of at least part of the reference line BL. The running course CS includes running condition data representing running conditions for the haul vehicle 2 running in the running area AR in the work site. The running condition data includes at least target running route data representing the target running route of the haul vehicle 2. Running condition data may include at least one of target running velocity data representing the target running velocity of the haul vehicle 2, target acceleration data representing the target acceleration of the haul vehicle 2, target deceleration data representing the target deceleration of the haul vehicle 2, target running direction data representing the target running direction of the haul vehicle 2, target stop position data representing the target stop position of the haul vehicle 2, and target departure position data representing the target departure position of the haul vehicle.

The input/output interface 13 outputs running course data representing the running course CS created by the running course creating unit 112 to the storage device 12. The input/output interface 13 also outputs reference line data representing the reference line BL created by the reference line creating unit 111 to the storage device 12. The input/output interface 13 also outputs the reference points BP and the course points CP to the storage device 12.

The input/output interface 13 also outputs the control points MP (to be described later) and the knot vectors to the storage device 12. The input/output interface 13 functions as an output unit that outputs the running course CS to the storage device 12. The storage device 12 stores the running course CS, the reference line BL, the reference points BP, the course points CP, the control points MP, and the knot vectors. Note that the running course CS has the control points MP and the knot vectors. In addition, the reference line BL has the control points MP and the knot vectors which are different from those described above. The input/output interface 13 also outputs running course data representing the running course CS created by the running course creating unit 112 and stored in the storage device 12 to the haul vehicle 2. The running course CS created by the arithmetic processor 11 is output to the haul vehicle 2 via the input/output interface 13 and the communication system 9. Note that at least one of the reference line BL, the reference points BP, or the control points MP and the knot vectors belonging to the reference line BL may not be stored in the storage device 12.

The controller 40 includes a computer system. The controller 40 includes an arithmetic processor 41 including a processor like a central processing unit (CPU) and a storage device 42 including a memory like a read only memory (ROM) or random access memory (RAM), and an input/output interface 43.

The controller 40 is connected to a wireless communication device 44. The wireless communication device 44 is disposed in the haul vehicle 2. The controller 40 communicates with the management apparatus 10 via the wireless communication device 44 and the communication system 9.

The controller 40 is connected to the driving device 31, a braking device 32, and a steering device 33. The controller 40 is also connected to a position detector 34 and a detector 35. The driving device 31, the braking device 32, the steering device 33, the position detector 34, and the detector 35 are mounted on the haul vehicle 2.

The driving device 31 operates to drive the running device 23 of the haul vehicle 2. The driving device 31 generates a driving force for driving the running device 23. The driving device 31 generates a driving force for rotating the rear wheels 25R. The driving device 31 includes an internal combustion engine such as a diesel engine. Note that the driving device 31 may include a generator that generates power by the operation of the internal combustion engine and an electric motor that operates on the basis of the power generated by the generator.

The braking device 32 operates to brake the running device 23. The braking device 32 operates to decelerate or stop the running of the running device 23.

The steering device 33 operates to steer the running device 23 of the haul vehicle 2. The haul vehicle 2 is steered by the steering device 33. The steering device 33 steers the front wheels 25F.

The position detector 34 detects the position (absolute position) of the haul vehicle 2. The position detector 34 includes a GNSS antenna that receives a GNSS signal from a GNSS satellite, a GNSS computing device that calculates the absolute position of the haul vehicle 2 on the basis of the GNSS signal received by the GNSS antenna, and a local coordinate converter that converts a position in the global coordinate system into a position in the local coordinate system.

The detector 35 detects the running direction of the haul vehicle 2. The detector 35 includes a steering angle sensor 35A that detects the steering angle of the haul vehicle 2 set by the steering device 33 and an azimuth angle sensor 35B that detects the azimuth angle of the haul vehicle 2. The steering angle sensor 35A includes a rotary encoder provided in, for example, the steering device 33. The azimuth angle sensor 35B includes a gyro sensor provided in, for example, the vehicle frame 21.

The arithmetic processor 41 includes a running course acquisition unit 411, a position data acquisition unit 412, a detection data acquisition unit 413, and a driving control unit 414.

The running course acquisition unit 411 acquires the running course CS created by the running course creating unit 112 of the management apparatus 10.

The position data acquisition unit 412 acquires position data representing the position of the haul vehicle 2 from the position detector 34.

The detection data acquisition unit 413 acquires the detection data obtained by the detector 35 that has detected the running direction of the haul vehicle 2 from the detector 35. The detection data includes the steering angle data detected by the steering angle sensor 35A and the azimuth angle data detected by the azimuth angle sensor 35B. The detection data acquisition unit 413 acquires steering angle data from the steering angle sensor 35A, and acquires azimuth angle data from the azimuth angle sensor 35B.

The driving control unit 414 outputs a control signal for controlling at least one of the driving device 31, the braking device 32, and the steering device 33 of the haul vehicle 2 on the basis of the running course CS acquired by the running course acquisition unit 411. The management apparatus 10 outputs the running course CS created by the running course creating unit 112 from the input/output interface 13 to the driving control unit 414 of the haul vehicle 2. The running course CS created by the running course creating unit 112 is transmitted from the input/output interface 13 to the driving control unit 414 of the haul vehicle 2.

The driving control unit 414 creates control signals for controlling the running of the haul vehicle 2 on the basis of the running course CS. The control signals created by the driving control unit 414 are output from the driving control unit 414 to the running device 23. The control signals output from the driving control unit 414 include an accelerator signal output to the driving device 31, a brake control signal output to the braking device 32, and a steering control signal output to the steering device 33. The driving control unit 414 controls the driving device 31, the braking device 32, and the steering device 33 so as to make the haul vehicle 2 run with the specific portion AP of the haul vehicle 2 coinciding with the running course CS on the basis of the position data detected by the position detector 34.

[Running Course Creating Method]

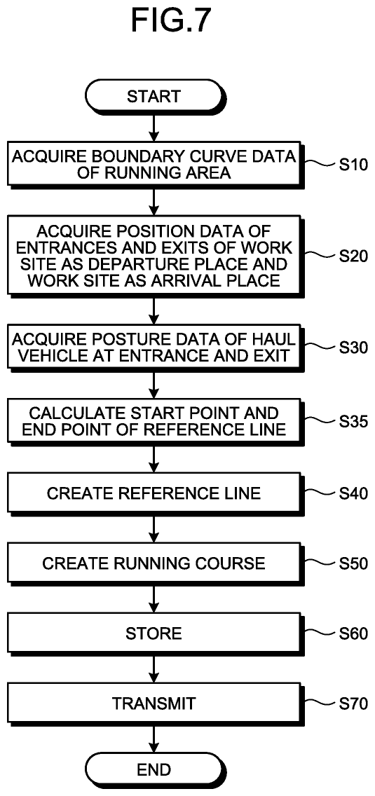

FIG. 7 is a flowchart illustrating an example of the method of creating the running courses CS according to this embodiment. This embodiment exemplifies a case in which the reference line BL and the running courses CS are set on the running road HL.

As illustrated in FIG. 7, the method of creating the running courses CS includes step S10 of acquiring boundary curve data representing the boundary curve FL of the running area AR, step S20 of acquiring the position data of the entrance Mi and the exit Mo of the work site PA as a departure place and the position data of the entrance Mi and the exit Mo of the work site PA as an arrival place, step S30 of acquiring the posture data of the haul vehicle 2 at the entrance Mi and the exit Mo of each work site PA, step S35 of calculating the start point data and the end point data of the reference line BL, step S40 of creating the reference line BL on the basis of the boundary curve FL, step S50 of creating the running courses CS on the basis of the reference line BL, step S60 of outputting the created running courses CS to the storage device 12 and making it store the running courses CS, and step S70 of transmitting the created running courses CS to the controller 40 of the haul vehicle 2.

In this embodiment, as initial conditions for the method of creating the running courses CS, the following are defined: boundary curve data representing the boundary curve FL of the running area AR; the position data of the entrance Mi of the work site PA; posture data representing the azimuth of the haul vehicle 2 at the entrance Mi; the position data of the exit Mo of the work site PA; and posture data representing the azimuth of the haul vehicle 2 at the exit Mo. As described above with reference to FIGS. 1 and 6 and the like, the mine includes the plurality of work sites PA, and the haul vehicle 2 runs on the running road HL from one work site PA to the other work site PA. The entrance Mi and the exit Mo are defined in each of the work sites PA as a departure place and an arrival place.

The management apparatus 10 acquires boundary curve data representing the boundary curve FL of the running area AR. The boundary curve FL includes at least one of the topographic boundary line DL and the survey line SL. Boundary curve data is point group data constituted by the plurality of boundary curve points FP whose positions in the local coordinate system are specified. Boundary curve data includes the position data of the boundary curve FL defined in the local coordinate system. Boundary curve data is stored in the storage device 12. The reference line creating unit 111 acquires boundary curve data from the storage device 12 (step S10). Note that the boundary curve data may be input to the management apparatus 10 via, for example, the input device 15.

The management apparatus 10 acquires the position data of the entrance Mi and the position data of the exit Mo of the work site PA as a departure place, and acquires the position data of the entrance Mi and the position data of the exit Mo of the work site PA as an arrival place (step S20). The position data of the entrance Mi is defined in the local coordinate system. The position data of the exit Mo is defined in the local coordinate system. The position data of the entrance Mi and the position data of the exit Mo can be derived from, for example, the design data obtained by a CAD. Note that the position data of the entrance Mi and the position data of the exit Mo may be acquired by surveying, derived from an aerial photo, or acquired by using the survey vehicle 5. The position data of the entrance Mi and the position data of the exit Mo are stored in, for example, the storage device 12. The reference line creating unit 111 acquires the position data of the entrance Mi and the exit Mo from the storage device 12. Note that the position data of the entrance Mi and the exit Mo may be input to the management apparatus 10 via, for example, the input device 15.

The management apparatus 10 acquires the posture data of the haul vehicle 2 at the entrance Mi, and acquires the posture data of the haul vehicle 2 at the exit Mo. The posture of the haul vehicle 2 includes the azimuth angle of the haul vehicle 2 relative to a reference azimuth. The posture data of the haul vehicle 2 is stored in the storage device 12. The reference line creating unit 111 acquires the posture data of the haul vehicle 2 at the entrance Mi and the exit Mo from the storage device 12 (step S30). The posture data of the haul vehicle 2 may be input to the management apparatus 10 via, for example, the input device 15.

Note that the execution order of processing in step S10, processing in step S20, and processing in step S30 is arbitrary. In addition, processing in step S10, processing in step S20, and processing in step S30 may be executed concurrently.

The reference line creating unit 111 then calculates the position of the start point of the reference line BL defined in the work site PA as a departure place and the azimuth of the haul vehicle 2 at the start point, and calculates the position of the end point of the reference line BL defined in the work site PA as an arrival place and the azimuth of the haul vehicle 2 at the end point (step S35). As described above, the start point of the haul vehicle 2 is calculated on the basis of the position data of the entrance Mi and the position data of the exit Mo in the work site PA as a departure place. In this embodiment, the start point of the haul vehicle 2 is located between the entrance Mi and the exit Mo in the departure place. The end point of the haul vehicle 2 is calculated on the basis of the position data of the entrance Mi and the position data of the exit Mo in the work site PA as an arrival place. In this embodiment, the end point of the haul vehicle 2 is located between the entrance Mi and the exit Mo in the arrival place. In addition, the azimuth of the haul vehicle 2 at the start point is calculated on the basis of, for example, the azimuth of the haul vehicle 2 at the exit Mo in the work site PA as a departure place, and the azimuth of the haul vehicle 2 at the end point is calculated on the basis of, for example, the azimuth of the haul vehicle 2 at the entrance Mi in the work site PA as an arrival place. The azimuths of the start point and the end point of the reference line BL may be calculated on the basis of the array of the reference points BP of the reference line BL or the array of candidate points BP′ of the reference points BP (which will be described later).

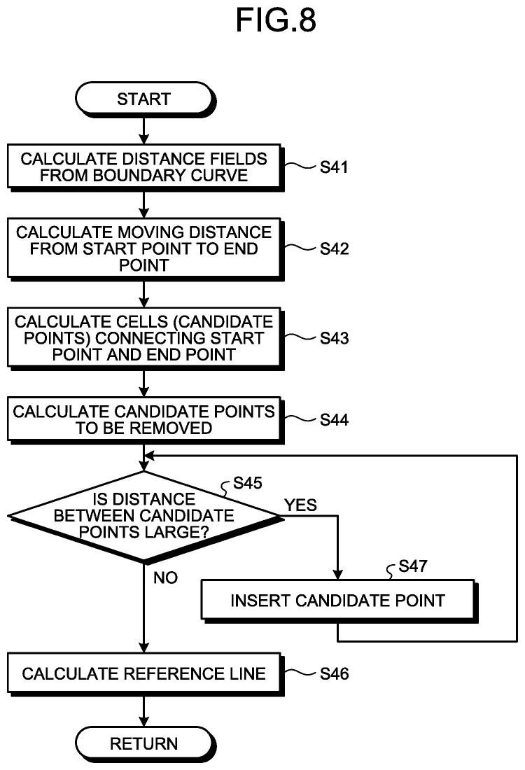

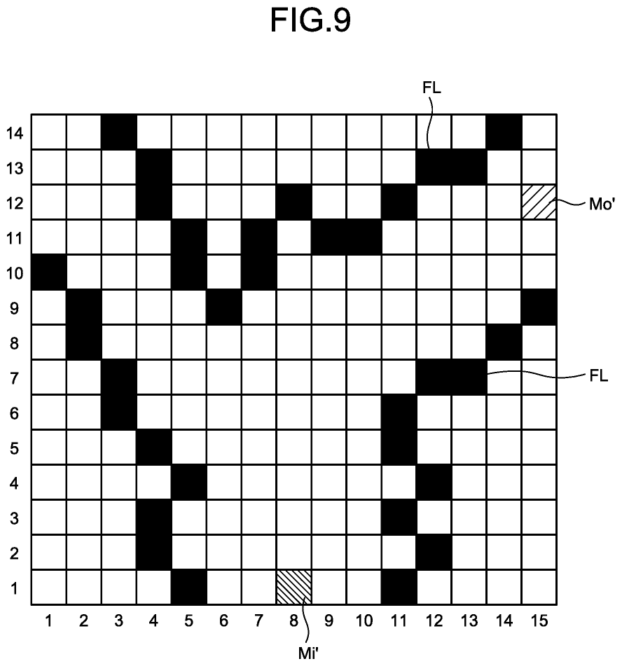

A method of creating the reference line BL (step S40) will be described next. FIG. 8 is a flowchart illustrating an example of the method of creating the reference line BL (step S40) according to this embodiment. FIGS. 9 to 18 are schematic views for explaining the method of creating the reference line BL according to the embodiment.

The reference line creating unit 111 creates the reference line BL such that the distance from the boundary curve FL is long, and the length of the reference line BL connecting the start point to the end point in the running area AR is short. That is, the reference line creating unit 111 creates the reference line BL such that the distance between each of the plurality of positions of the reference line BL and the boundary curve FL is as long as possible, and the distance between the start point and the end point at each of the plurality of positions of the reference line BL is as short as possible.

FIG. 9 is a view illustrating an example of a mesh graph set in the work site. The mesh graph is a graph expressed by a mesh constituted by a plurality of cells.

Note that FIGS. 9 to 14 each simply illustrate the work site in the form of a 14 row×15 column mesh for the sake of descriptive simplicity.

As illustrated in FIG. 9, the reference line creating unit 111 sets a mesh graph in the work site including the running road HL. The reference line creating unit 111 sets the boundary curve FL in a plurality of cells on the basis of the boundary curve data acquired in step S10. The reference line creating unit 111 also sets a start point and an end point in some cells on the basis of the coordinate data of the start point and the end point calculated in step S35. In the following description, a start point and an end point are expressed as a start point Mo′ and an end point Mi′, respectively.

The reference line creating unit 111 then calculates the distance field between each of a plurality of cells and the boundary curve FL (step S41). The reference line creating unit 111 assigns a distance field, which is a value representing the distance from the boundary curve FL, to each of a plurality of cells. Distance fields may be calculated by, for example, a fast marching method as a speed-up technique for a level set method.

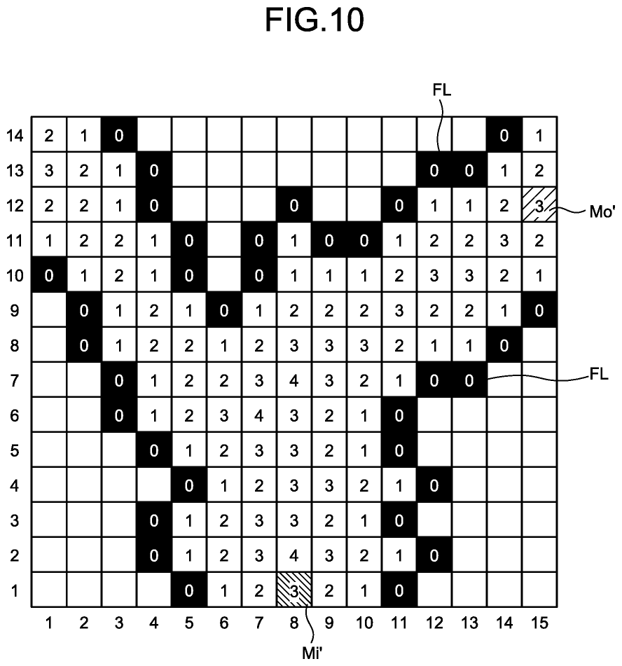

FIG. 10 is a view illustrating an example of cells assigned with distance fields. The distance between each cell indicating the boundary curve FL and the boundary curve FL is 0. Accordingly, each cell indicating the boundary curve FL is assigned with “0” as a distance field.

The distance between each cell adjacent to each cell indicating the boundary curve FL and the boundary curve FL is short. Accordingly, each cell adjacent to each cell indicating the boundary curve FL is assigned with “1” as a distance field. Each cell adjacent to each cell assigned with a distance field of “1” is more distant from the boundary curve FL than each cell assigned with a distance field of “1”. Accordingly, each cell adjacent to each cell assigned with a distance field of “1” is assigned with a distance field of “2”. Likewise, each cell is assigned with a larger distance field with an increase in distance from each cell indicating the boundary curve FL. In the case illustrated in FIG. 10, each cell located more distant from the boundary curve FL than each cell assigned with a distance field of “2” is assigned with a distance field of “3”, and each cell located more distant from the boundary curve FL than each cell assigned with a distance field of “3” is assigned with a distance field of “4”.

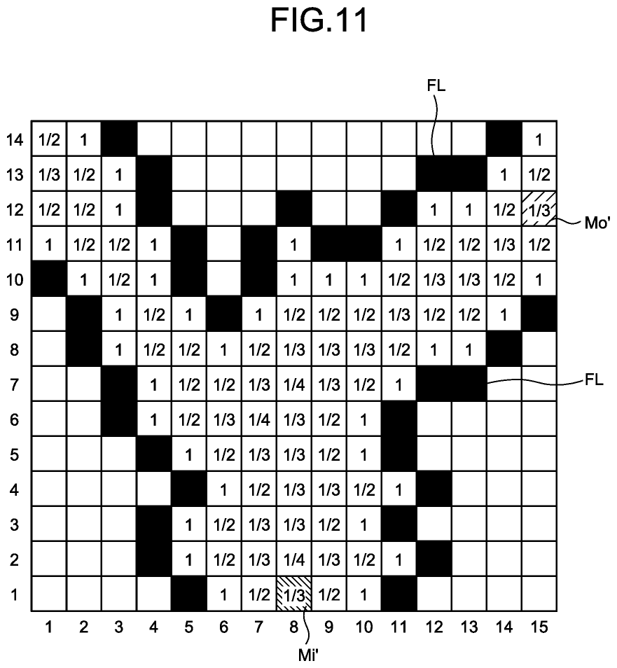

The reference line creating unit 111 calculates the reciprocal of the distance field for each of a plurality of cells. FIG. 11 is a view illustrating an example of cells assigned with the reciprocals of distance fields. The reference line BL is preferably set in a middle portion of the running road HL. That is, the reference line BL is preferably set such that the distance from the boundary curve FL becomes long. In the calculation of a total cost (to described later), the reference line creating unit 111 calculates the reciprocal of each distance field in order to create the reference line BL by calculating an evaluation value so as to reduce the total cost in consideration of the distance to the end point Mi′.

In this embodiment, for the sake of convenience, the reciprocal of each distance field will be referred to as a movement cost.

The reference line creating unit 111 then calculates the movement distance from the start point Mo′ to each cell C (step S42).

In this embodiment, for the sake of convenience, the movement distance from the start point Mo′ to each cell C will be referred to as an estimated cost.

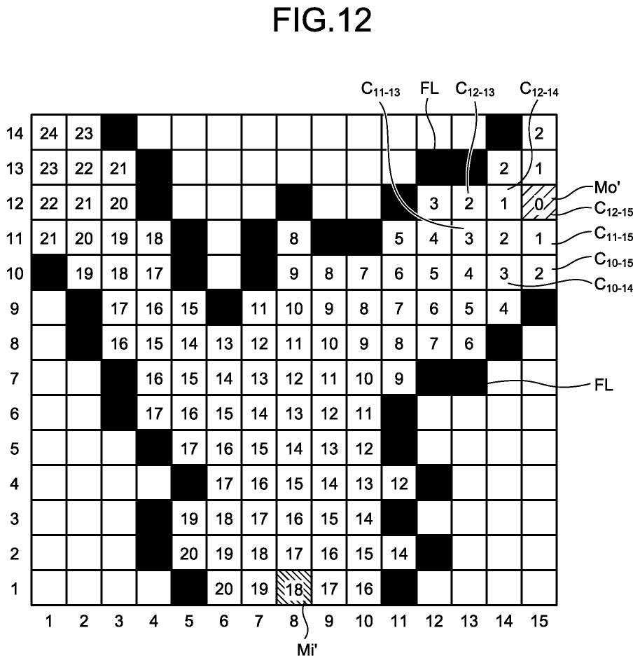

FIG. 12 is a view illustrating an estimated cost from the start point Mo′ to the end point Mi′ which is assigned to each cell. A cell C₁₂₋₁₅ indicating the start point Mo′ is assigned with “0” as an estimated cost.

A cell C₁₁₋₁₅ adjacent to the cell C₁₂₋₁₅ in the row direction is assigned with “1” as an estimated cost. A cell C₁₂₋₁₄ adjacent to the cell C₁₂₋₁₅ in the column direction is assigned with “1” as an estimated cost.

A cell C₁₀₋₁₅ adjacent to the cell C₁₁₋₁₅ in a direction more distant from the start point Mo′ than the cell C₁₁₋₁₅ in the row direction is assigned with “2” as an estimated cost. A cell C₁₂₋₁₃ adjacent to the cell C₁₂₋₁₄ in a direction more distant from the start point Mo′ than the cell C₁₂₋₁₄ in the column direction is assigned with “2” as an estimated cost.

A cell C₁₀₋₁₄ adjacent to the cell C₁₀₋₁₅ in a direction more distant from the start point Mo′ than the cell C₁₀₋₁₅ in the column direction is assigned with “3” as an estimated cost. A cell C₁₁₋₁₃ adjacent to the cell C₁₂₋₁₃ in a direction more distant from the start point Mo′ than the cell C₁₂₋₁₃ in the row direction is assigned with “3” as an estimated cost.

Likewise, subsequently, the cells adjacent to the cells, each assigned with “3” as an estimation cost, in directions more distant from the start point Mo′ than the cells, each assigned with “3” as an estimation cost, in the row and column directions, each are assigned with “4” as an estimated cost. The cells adjacent to the cells, each assigned with “4” as an estimation cost, in directions more distant from the start point Mo′ than the cells, each assigned with “4” as an estimation cost, in the row and column directions, each are assigned with “5” as an estimated cost. As described above, larger estimated costs are assigned to cells with an increase in distance from the start point Mo′. In the case illustrated in FIG. 11, a cell indicating the end point Mi′ is assigned with “18” as an estimated cost. A cell most distant from the start point Mo′ in the running area AR is assigned with “24” as an estimated cost.

As described above, in order to facilitate arithmetic processing, this embodiment uses a method of adding “1” as an estimated cost every time a given cell is shifted by one cell in the row or column direction. Note that the linear distance (geometric distance) between a cell indicating the start point Mo′ and each of a plurality of cells other than the start point Mo′ may be calculated to determine an estimated cost assigned to each of the plurality of cells on the basis of the linear distance.

In this manner, an estimated cost can be expressed by a numerical value corresponding to the distance from the start point Mo′ which is assigned to each of the plurality of cells. Estimated costs decrease with a decrease in distance from the start point Mo′.

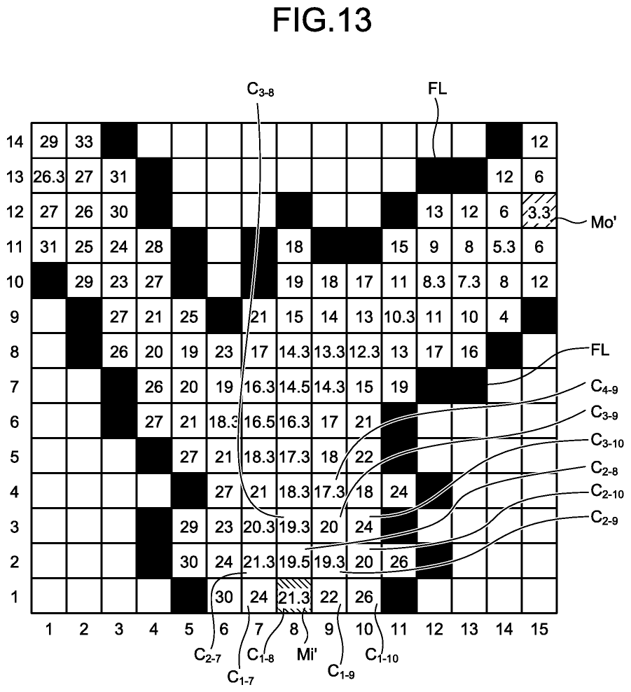

The reference line creating unit 111 then calculates a total cost concerning each of a plurality of cells. FIG. 13 is a view illustrating total costs respectively assigned to a plurality of cells. A total cost is the sum of a movement cost and an estimated cost. The reference line creating unit 111 calculates the sum of a movement cost represented by the reciprocal of a distance field described with reference to FIG. 11 and an estimated cost represented by a movement distance from the start point Mo′ described with reference to FIG. 12 for each of a plurality of cells.

Note that in this embodiment, the reference line creating unit 111 calculates, as a total cost, the sum of the product of a movement cost and a constant and an estimated cost ([total cost]=[movement cost]×[constant]+[estimated cost]). A constant is set to an arbitrary value in accordance with, for example, the size of a cell or the size of the running area AR. The case illustrated in FIG. 13 illustrates total costs when the constant is set to “10”. FIG. 13 illustrates the values obtained by rounding off to the second decimal place as round numbers of total costs. Note that the constant need not be “10” and may be set to an arbitrary value.

The reference line creating unit 111 then calculates cells constituting a route connecting the start point Mo′ to the end point Mi′ so as to minimize total costs (step S43). Cells connecting the start point Mo′ to the end point Mi′ and having minimum total costs are set as the candidate points BP′ of the reference points BP.

The reference line creating unit 111 selects a cell having the minimum total cost from the plurality of cells existing around a cell C₁₋₈ indicating the end point Mi′. In the case illustrated in FIG. 13, there are a cell C₁₋₉ with a total cost of “22”, a cell C₂₋₉ with a total cost of “19.3”, a cell C₂₋₈ with a total cost of “19.5”, a cell C₂₋₇ with a total cost of “21.3”, and a cell C₁₋₇ with a total cost of “24” around a cell C₁₋₈ indicating the entrance Mi. The cell having the minimum total cost among the total costs of the plurality of cells around the cell C₁₋₈ indicating the entrance Mi is the cell C₂₋₉ with “19.3”. Accordingly, the reference line creating unit 111 selects the cell C₂₋₉ with “19.3” from the plurality of cells existing around the cell C₁₋₈.

The reference line creating unit 111 then selects a cell having the minimum total cost from the plurality of cells existing around the cell C₂₋₉ with “19.3”. In the case illustrated in FIG. 13, there are a cell C₂₋₁₀ with a total cost of “20”, a cell C₃₋₁₀ with a total cost of “24”, a cell C₃₋₉ with a total cost of “20”, a cell C₃₋₈ with a total cost of “19.3, a cell C₂₋₈ with a total cost of “19.5”, a cell C₁₋₈ with a total cost of “21.3”, a cell C₁₋₉ with a total cost of “22”, and a cell C₁₋₁₀ with a total cost of “26” around a cell C₂₋₉ with a total cost of “19.3”. The cell having the minimum total cost among the total costs of the plurality of cells existing around the cell C₂₋₉ is the cell C₃₋₈ with “19.3”. Accordingly, the reference line creating unit 111 selects the cell C₃₋₈ with “19.3” from the plurality of cells existing around the cell C₂₋₉.

The reference line creating unit 111 then selects a cell having a minimum total cost from a plurality of cells existing around a plurality of cells existing around the cell C₃₋₈ with “19.3”. In the case illustrated in FIG. 13, the cell having the minimum total cost among the plurality of cells existing around the cell C₃₋₈ is a cell C₄₋₉ with “17.3”. Accordingly, the reference line creating unit 111 selects the cell C₄₋₉ with “17.3” from the plurality of cells existing the cell C₃₋₈.

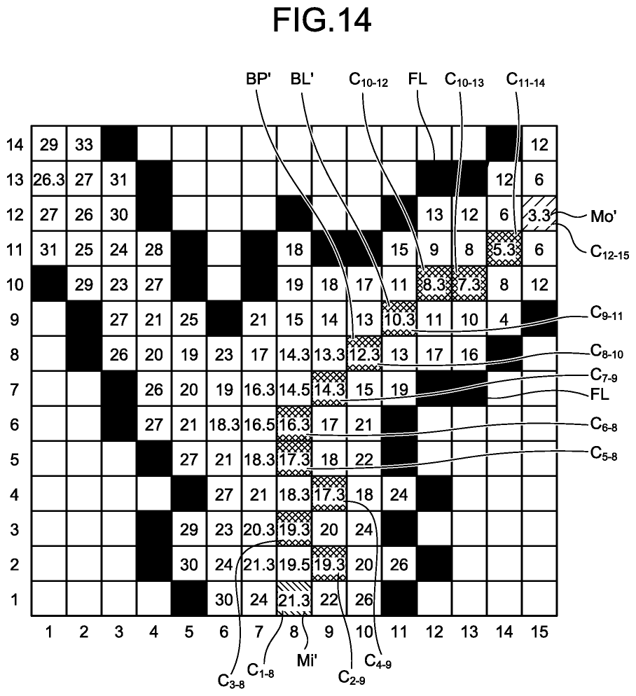

Subsequently, in the same procedure as described above, the reference line creating unit 111 sequentially searches for cells having small total costs from the entrance Mi to the exit Mo. FIG. 14 is a view illustrating the result obtained by searching for cells having minimum total costs and connecting the end point Mi′ to the start point Mo′. As illustrated in FIG. 14, in this embodiment, the cell C₁₋₈ indicating the end point Mi′ and the cell C₁₂₋₁₅ indicating the start point Mo′ are connected to each other via the cell C₂₋₉, the cell C₃₋₈, the cell C₄₋₉, a cell C₅₋₈, a cell C₆₋₈, a cell C₇₋₉, a cell C₈₋₁₀, a cell C₉₋₁₁, a cell C₁₀₋₁₂, a cell C₁₀₋₁₉, and a cell C₁₁₋₁₄. These cells C become the candidate points BP′ of the reference points BP.

In this manner, the reference line creating unit 111 can search for a route with a minimum total cost which connects the end point Mi′ to the start point Mo′ by sequentially searching for cells having smaller total costs from the end point Mi′ to the start point Mo′. In this embodiment, the route constituted by the cell C₂₋₉, the cell C₃₋₈, the cell C₄₋₉, the cell C₅₋₈, the cell C₆₋₈, the cell C₇₋₉, the cell C₈₋₁₀, the cell C₉₋₁₁, the cell C₁₀₋₁₂, the cell C₁₀₋₁₉, and the cell C₁₁₋₁₄ that connect the cell C₁₋₈ indicating the end point Mi′ to the cell C₁₂₋₁₅ indicating the start point Mo′ indicate a candidate line BL′ of the reference line BL, and the cell C₂₋₉, the cell C₉₋₉, the cell C₄₋₉, the cell C₅₋₈, the cell C₆₋₈, the cell C₇₋₉, the cell C₈₋₁₀, the cell C₉₋₁₁, the cell C₁₀₋₁₂, the cell C₁₀₋₁₉, and the cell C₁₁₋₁₄ each indicate the candidate point BP′ of the reference point BP. That is, the candidate points BP′ of the reference points BP include the cells constituting the candidate line BL′ of the reference line BL connecting the end point Mi′ to the start point Mo′ so as to have the minimum total cost.

As described above, the movement costs of cells decrease with an increase in distance from the boundary curve FL. The estimated costs decrease with a decrease in distance from the start point Mo′. The candidate line BL′ of the reference line BL is constituted by cells having minimum total costs each of which is the sum of a movement cost and an estimated cost. That is, in this embodiment, the reference line creating unit 111 creates the candidate line BL′ of the reference line BL such that the distance from the boundary curve FL becomes long, and the length of the candidate line BL′ of the reference line BL connecting the start point Mo′ to the end point Mi′ becomes short.

Note that the reference line creating unit 111 may search for a route having a minimum total cost by using an A*(A-star) route search algorithm. The A*(A-star) route search algorithm calculates no unnecessary route costs, and hence can execute arithmetic processing at high speed.

Upon calculating the candidate line BL′ of the reference line BL in step S43, the reference line creating unit 111 executes the processing of adjusting the candidate line BL′ of the reference line BL calculated in step S43 to create a more optical reference line BL and a more optical running course CS.

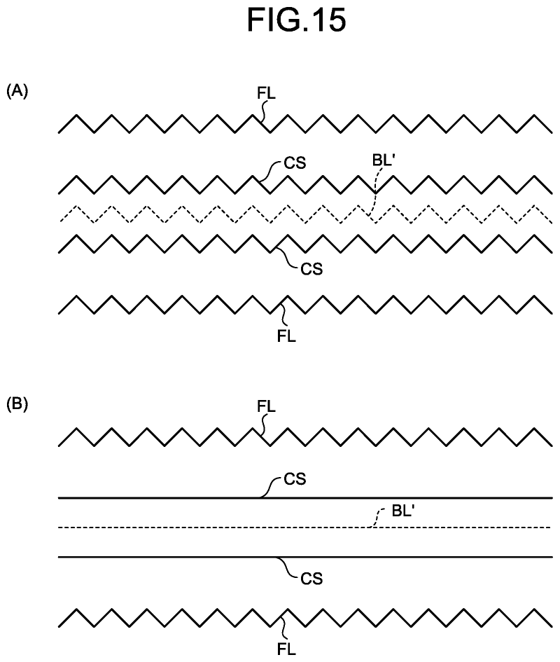

FIG. 15 is a view schematically illustrating an example of the candidate line BL′ of the reference line BL created by the reference line creating unit 111. For example, the influence of the shape of the boundary curve FL may be left on the shape of the candidate line BL′ created in step S43. For this reason, as illustrated in FIG. 15(A), if, for example, the boundary curve FL has undulations, the reference line BL created on the basis of the boundary curve FL may unnecessarily meander. When the reference line BL meanders, as illustrated in FIG. 15(A), the running course CS created on the basis of the reference line BL may also unnecessarily meander.

As illustrated in FIG. 15(B), even if the boundary curve FL has undulations, the reference line BL set on the running road HL and the running course CS created on the basis of the reference line BL preferably have shapes that minimize the operation amount of the steering device 33 of the haul vehicle 2 as long as the haul vehicle 2 can run on the running road HL.

If, for example, the running road HL is curved, the reference line BL and the running course CS created on the basis of the reference line BL are preferably curved smoothly so as to minimize the operation amount of the steering device 33 of the haul vehicle 2 within a range in which the haul vehicle 2 can run on the running road HL.

In this embodiment, the reference line BL is adjusted so as to allow the haul vehicle 2 to efficiently run without making the running course CS created on the basis of the reference line BL be excessively influenced by the shape of the boundary curve FL.

In order to adjust the reference line BL, the reference line creating unit 111 selects some candidate points BP′ from the candidate points BP′ of the plurality of reference points BP calculated on the basis of the boundary curve FL, and removes the remaining some of the candidate points BP′. The reference line creating unit 111 calculates the candidate points BP′ to be removed (step S44).

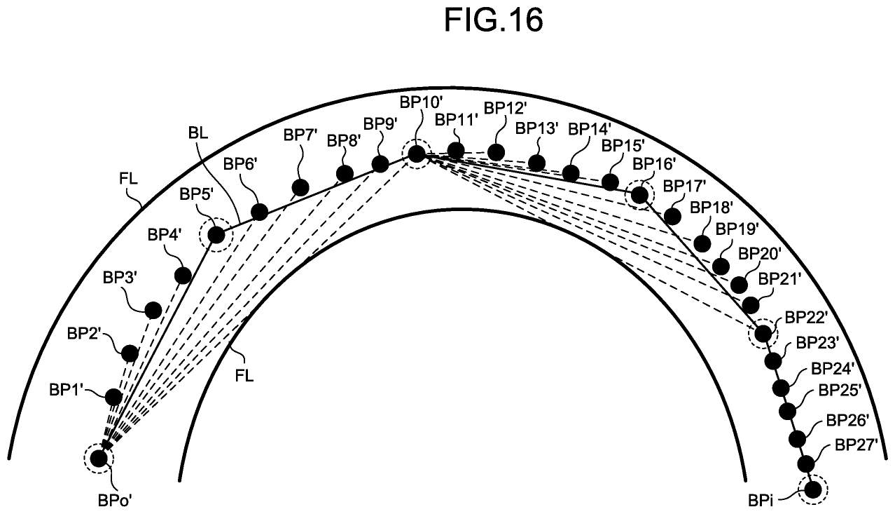

FIG. 16 is a view illustrating an example of a method of adjusting the reference line BL according to this embodiment. As described above, the reference line BL is defined by the candidate points BP′ of the plurality of reference points BP with minimum total costs. The positions of the candidate points BP′ are the positions of representative points (for example, the central coordinates of cells) of cells in a mesh graph.

The positions of each candidate point BP′ is determined for each cell in the mesh graph. There are a large number of candidate points BP′. Accordingly, when the reference line BL is to be created by connecting all the candidate points BP′ calculated in step S43, the excessive number of reference points BP may cause the reference line BL to unnecessarily meander.

Upon determining a plurality of candidate points BP′ defining the reference line BL in step S43, the reference line creating unit 111 performs the processing of selecting some candidate points BP′ from the plurality of candidate points BP′ and removing the remaining some of the candidate points BP′ (thinning out the candidate points BP′) and increases the distances between the adjacent candidate points BP′.

As illustrated in FIG. 16, the reference line creating unit 111 calculates a plurality of candidate points BP1′ to BP27′ connecting the candidate point BPo′ indicating the start point Mo′ to the candidate point BPi′ indicating the end point Mi′ by executing the processing from step S41 to step S43. The candidate point BPo′ corresponds to a cell indicating the start point Mo′ in the mesh graphs illustrated in FIGS. 9 to 14. The candidate point BPi′ corresponds to a cell indicating the end point Mi′ in the mesh graphs illustrated in FIGS. 9 to 14. The candidate points BP1′ to BP27′ respectively correspond to cells with minimum total costs, which connect the start point Mo′ to the end point Mi′ in the mesh graphs illustrated in FIG. 9 to FIG. 14.

The reference line creating unit 111 calculates line segments connecting the candidate point BPo′ to the candidate point BP1′ and to each of candidate points up to the candidate point BPi′ sequentially from the candidate point BP1′ to the candidate point BP27′, and determines the candidate point BP′ that first comes into contact with the boundary curve FL. In the case illustrated in FIG. 16, line segments respectively connecting the candidate point BPo′ to the candidate points BP1′ to BP27′ are calculated, and the line segment connecting the candidate point BPo′ to the candidate point BP10′ comes into contact with the boundary curve FL. In this embodiment, the reference line creating unit 111 selects the candidate point BP10′ and the candidate point BP5′ located at the middle point between the candidate point BPo′ and the candidate point BP10′ from the plurality of candidate points BP1′ to BP10′, and removes (thins out) the candidate points BP1′ to BP4′ and the candidate points BP6′ to BP9′.

The reference line creating unit 111 then calculates straight lines respectively connecting the candidate point BP10′ to the candidate points BP11′ to candidate point BPi′, and determines a straight line, of the plurality of straight lines, which comes into contact with the boundary curve FL and has the minimum length. In the case illustrated in FIG. 16, straight lines respectively connecting the candidate point BP10′ to the candidate points BP11′ to BP22′ are calculated, and the straight line connecting the candidate point BP10′ to the candidate point BP22′ comes into contact with the boundary curve FL. In this embodiment, the reference line creating unit 111 selects the candidate point BP22′ and the candidate point BP16′ located at the middle point between the candidate point BP10′ and the candidate point BP22′ from the plurality of candidate points BP11′ to BP22′, and removes (thins out) the candidate points BP11′ to BP15′ and the candidate points BP17′ to BP21′.

Subsequently, the reference line creating unit 111 repeats the above processing until a straight line is connected to the candidate point BPi′. The reference line creating unit 111 creates the reference line BL by interpolating for the selected candidate points BPo′, BP5′, BP10′, BP16′, BP22′, and BPi′. In the case illustrated in FIG. 16, the reference line BL is defined on the basis of the candidate points BPo′, BP5′, BP10′, BP16′, BP22′, and BPi′.

With the above operation, the reference line creating unit 111 terminates the processing of determining the reference points BP upon thinning out the specific candidate points BP′ from the plurality of candidate points BP′. In the case illustrated in FIG. 16, the determined reference points BP are the candidate points BPo′, BP5′, BP10′, BP16′, BP22′, and candidate point BPi′. The reference line creating unit 111 can create the reference line BL little influenced by the shape of the boundary curve FL by determining the reference points BP by the selection of some candidate points BP′ from the plurality of candidate points BP′ and interpolating for the determined reference points BP. Even if, for example, the boundary curve FL has undulations, the reference line creating unit 111 can create the smooth reference line BL little influenced by the shape of the boundary curve FL. The reference line creating unit 111 can create the reference line BL with little change in curvature by interpolating for the thinned-out reference points BP.

The reference line creating unit 111 determines whether the distances between the adjacent candidate points BP′, which are selected upon removal of some candidate points BP′, each are larger than a threshold (step S45). That is, the reference line creating unit 111 determines whether the candidate points BP′ have excessively thinned out. The threshold is a value determined in advance concerning the distances between the adjacent candidate points BP′ and stored in the storage device 12.

Upon determining in step S45 that the distance between the candidate points BP′ is larger than the threshold (step S45: Yes), that is, the candidate points BP′ have been excessively thinned out, the reference line creating unit 111 inserts the removed candidate points BP′ between the adjacent candidate points BP′ (step S47). Upon inserting the candidate points BP′, the reference line creating unit 111 executes the processing in step S45.

Upon determining in step S45 that the distance between the candidate points BP′ is equal to or less than the threshold (step S45: No), the reference line creating unit 111 creates the reference line BL by interpolating for the selected candidate points BP′ (step S46).

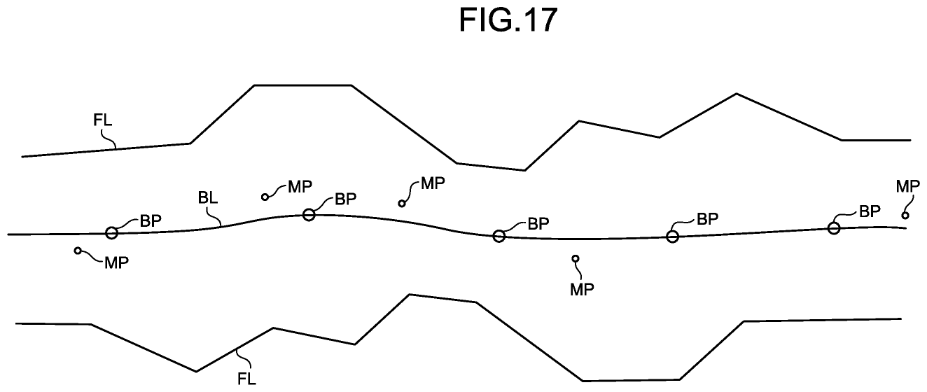

FIG. 17 is a view schematically illustrating an example of the reference line BL calculated on the basis of the selected reference points BP. As an initial condition for the creation of the reference line BL, the posture data of the haul vehicle 2 at a start point and an end point are provided. The posture data of the haul vehicle 2 at the start point is the posture data of the haul vehicle 2 at the exit Mo of the departure place which is acquired in step S30. The posture data of the haul vehicle 2 at the end point is the posture data of the haul vehicle 2 at the entrance Mi of the arrival place which is acquired in step S30. Note that the posture data of the haul vehicle 2 at the start point may be the posture data of the haul vehicle 2 at the entrance Mi of the departure place which is acquired in step S30. The posture data of the haul vehicle 2 at the end point may be the posture data of the haul vehicle 2 at the exit Mo of the arrival place which is acquired in step S30. In addition, the posture data of the haul vehicle 2 at the start point and the end point each may be determined on the basis of the array of the reference points BP or the array of the candidate points BP′ of the reference points BP. The reference line BL is created so as to pass through all the reference lines BP. The reference line creating unit 111 calculates a B-spline curve on the basis of a plurality of reference points BP. A B-spline curve is a smooth curve defined on the basis of a plurality of set control points MP, set knot vectors, and a set base function.

The reference line creating unit 111 creates the reference line BL from the B-spline curve by executing interpolation on the basis of the control points MP so as to pass through a plurality of reference points BP. As illustrated in FIG. 17, the reference line creating unit 111 sets the control points MP so as to allow the haul vehicle 2 to run as fast as possible on the reference line BL passing through the plurality of reference points BP.

Larger swing radii allow the haul vehicle 2 to run as linearly as possible at higher speeds. In addition, with a decrease in steering change amount indicating the change amount of steering amount of the steering device 33, the haul vehicle 2 can run at higher speeds. The reference line creating unit 111 creates the reference line BL by setting the control points MP so as to increase the turning radius of the haul vehicle 2 and reduce the steering change amount of the steering device 33 of the haul vehicle 2 per unit time.

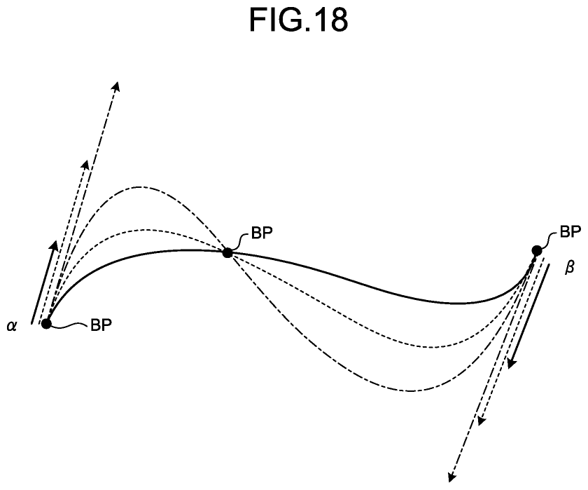

FIG. 18 is a view schematically illustrating an example of a method of creating the reference line BL according to this embodiment. FIG. 18 exemplifies the three reference points BP. Let a be the magnitude of a tangent vector on the reference point BP at one end of the three reference points BP, and p be the magnitude of a tangent vector on the reference point BP at the other end. The shape of the B-spline curve to be interpolated changes depending on the magnitudes a and p of the contact vectors.

In this embodiment, the magnitudes a and p of the contact vectors are calculated, on the basis of a target energy function E represented by mathematical expression (1), so as to increase the turning radius of the haul vehicle 2 and reduce the change amount of steering amount of the steering device 33 per unit time. Although four conditions are considered in mathematical expression (1), an optimal tangent vector can be calculated by adding a new term and considering the corresponding condition. In addition, adjusting weights can change the contribution degrees of the respective conditions.

$$E ≡ {ω}_{1} \int {k}^{2} ds + {ω}_{2} \int {( \frac{dk}{ds} )}^{2} ds + {ω}_{3} \int ds + {ω}_{4} {\sum }_{i = 0}^{m} {( {Q}_{i}^{′} - {Q}_{i} )}^{2} \\ \int {k}^{2} ds \text{:} TURNING RADIUS TERM \\ \int {( \frac{dk}{ds} )}^{2} ds \text{:} STEERING CHANGE AMOUNT PER UNIT TIME \\ \int ds \text{:} TOTAL COURSE LENGTH \\ {\sum }_{i = 0}^{m} {( {Q}_{i}^{′} - {Q}_{i} )}^{2} \text{:} CHANGE AMOUNT OF REFERENCE POINT POSITION \\ {ω}_{1} , {ω}_{2} , {ω}_{3} , {ω}_{4} \text{:} WEIGHT \qquad ( 1 )$$

Note that in this embodiment, interpolation is executed to create the reference line BL so as to pass through a plurality of reference points BP. The reference line BL may be created so as to pass through near the reference points BP instead of passing through the reference points BP. For example, the reference line creating unit 111 may execute interpolation processing based on approximation so as to increase the turning radius of the haul vehicle 2 and reduce the change amount of steering amount of the steering device 33 per unit time. Approximation is interpolation processing for creating an approximate curve on the basis of a plurality of reference points BP. A created approximate curve sometimes does not pass through the reference points BP.

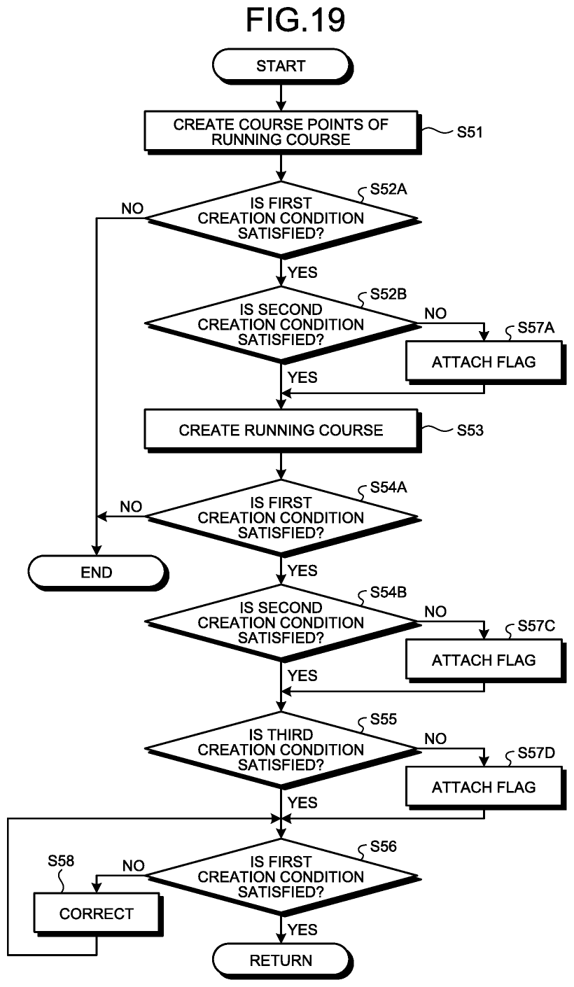

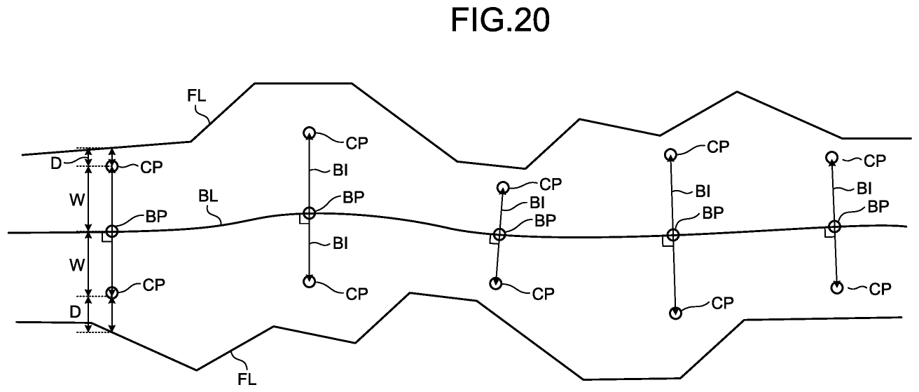

A method of creating the running course CS (step S50) will be described next. FIG. 19 is a flowchart illustrating an example of the method of creating the running course CS (step S50) according to this embodiment. FIGS. 20 to 24 are schematic views for explaining the method of creating the running course CS according to this embodiment.

The running course creating unit 112 creates, from the reference points BP created in step S40, the course points CP of the running course CS at positions that are perpendicular to the reference line BL and separated from the reference points BP by a distance W (step S51).

FIG. 20 is a view schematically illustrating a method of creating the course points CP. As illustrated in FIG. 20, the running course creating unit 112 creates imaginary lines BI that pass through the respective reference points BP and are perpendicular to the reference line BL. The course points CP are created at positions on the imaginary lines BI which are respectively separated from the reference points BP by the distance W.

In this embodiment, the running course creating unit 112 determines, for each of the plurality of reference points BP, the distance W between the reference point BP and the course point CP so as to satisfy a first creation condition set in advance in the creation of the course point CP. The running course creating unit 112 also determines, for each of the plurality of reference points BP, the distance W between the reference point BP and the course point CP so as to satisfy a second creation condition set in advance in the creation of the course point CP.

The first creation condition is a condition under which the haul vehicle 2 runs in the running area AR according to the running course CS. That is, the first creation condition is a condition under which at least part of the haul vehicle 2 does not run off to the forbidden area ER outside the boundary curve FL, or a condition under which the haul vehicle 2 does not come into contact with the boundary curve FL. The position data of the boundary curve FL in the local coordinate system is known data. Accordingly, determining the distance W will determine a distance D between each course point CP and the boundary curve FL. In addition, the outer shape data of the haul vehicle 2 is the design data of the haul vehicle 2 or known data derived from specification data, which is stored in the storage device 12. The outer shape data of the haul vehicle 2 includes the outer shape dimensions of the haul vehicle 2. Accordingly, the running course creating unit 112 can create the running points CP by determining the distance W on the basis of the position data of the boundary curve FL and the outer shape data of the haul vehicle 2 so as to satisfy the first creation condition under which the haul vehicle 2 runs in the running area AR.

The second creation condition is a condition under which the haul vehicle 2 running on one side of the reference line BL along the running course CS1 and the haul vehicle 2 running on the other side of the reference line BL along the running course CS2 can travel in opposite directions. That is, the second creation condition is a condition under which the haul vehicle 2 running on one side of the reference line BL and the haul vehicle 2 running on the other side of the reference line BL can pass each other without physical contact. If the distance W is too short relative to the outer shape dimensions of the haul vehicle 2, the haul vehicles 2 cannot pass each other. The running course creating unit 112 can determine the distance W and create the running points CP, on the basis of the outer shape data of the haul vehicle 2, so as to satisfy the second running condition under which the haul vehicle 2 running on one side of the reference line BL along the running course CS1 and the haul vehicle 2 running on the other side of the reference line BL along the running course CS2 can travel in opposite directions.

After creating the course points CP in step S51, the running course creating unit 112 determines whether the created course points CP satisfy the first creation condition (step S52A). The running course creating unit 112 can determine, based on the position data of the boundary curve FL and the outer shape data of the haul vehicle 2, whether the course points CP satisfy the first creation condition. The running course creating unit 112 also determines whether each of all the course points CP satisfies the first creation condition.

Upon determining in step S52A that all the course points CP do not satisfy the first creation condition (step S52A: No), the running course creating unit 112 adjusts the distance D between each course point CP and the boundary curve FL and the distance W between the course point CP and the reference line BP by moving the course point CP. Upon determining that the course points CP do not satisfy the first creation condition even upon moving the course points

CP, the running course creating unit 112 terminates the processing. Assume that when the distance D is determined upon moving the course points CP so as to satisfy the first creation condition, the distance W takes a negative value. In this case, the running course creating unit 112 determines that the running course CS cannot be created near the reference point BP corresponding to the course points CP because, for example, the width of the running road HL is small, and terminates the processing.

Upon determining in step S52A that the course points CP satisfy the first creation condition (step S52A: Yes), the running course creating unit 112 determines whether the created course points CP satisfy the second creation condition (step S52B). The running course creating unit 112 determines, based on the outer shape data of the haul vehicle 2, whether the course points CP satisfy the second creation condition.

Upon determining in step S52B that the course points CP do not satisfy the second creation condition (step S52B: No), the running course creating unit 112 corrects the positions of the course points CP so as to satisfy the first creation condition and the second creation condition. That is, if there is still room to adjust the positions of the course points CP so as to satisfy both the first creation condition and the second creation condition, the running course creating unit 112 adjusts the positions of the course points CP. After correcting the positions of the course points CP, the running course creating unit 112 determines whether the corrected course points CP satisfy the first creation condition. If the corrected course points CP satisfy the first creation condition, the running course creating unit 112 determines (updates) the corrected course points CP as the course points CP for creating the running course CS. If the corrected course points CP do not satisfy the first creation condition, the running course creating unit 112 sets flags at the corresponding course points CP (step S57A).

This flag is used to determine whether, when, for example, the haul vehicle 2 running along the running course CS1 and the haul vehicle 2 running along the running course CS2 simultaneously run near the course points CP, causing one haul vehicle 2 to stop (stand by) allows the other haul vehicle 2 to pass through.

The running course creating unit 112 creates the running course CS by interpolating for a plurality of course points CP (step S53).

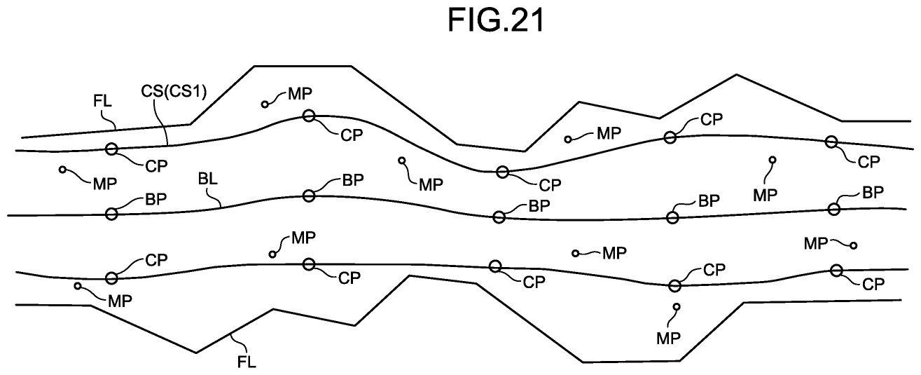

FIG. 21 is a view schematically illustrating an example of each running course CS calculated on the basis of the course points CP. The running course CS is created so as to pass through all the course points CP. In this embodiment, the running course creating unit 112 creates the running course CS by the same method as that by which the reference line creating unit 111 creates the reference line BL. That is, the running course creating unit 112 calculates a B-spline curve on the basis of a plurality of course points CP. The running course creating unit 112 creates the running course CS from the B-spline curve by executing interpolation on the basis of the control points MP so as to pass through the plurality of course points CP. As an initial condition in the creation of the running course CS, the posture data of the haul vehicle 2 at the entrance Mi and the exit Mo which are acquired in step S30 are provided. The running course creating unit 112 creates the running course CS by setting the control points MP so as to increase the turning radius of the haul vehicle 2 and reduce the steering change amount of the steering device 33 of the haul vehicle 2 per unit time.

The running course creating unit 112 determines whether the running course CS created in step S53 satisfies the first creation condition (step S54A).

Even if the course points CP satisfy the first creation condition and the second creation condition, part of the running course CS created by interpolating the course points CP may not satisfy the first creation condition. Accordingly, the running course creating unit 112 determines whether the running course CS created in step S53 satisfies the first creation condition.

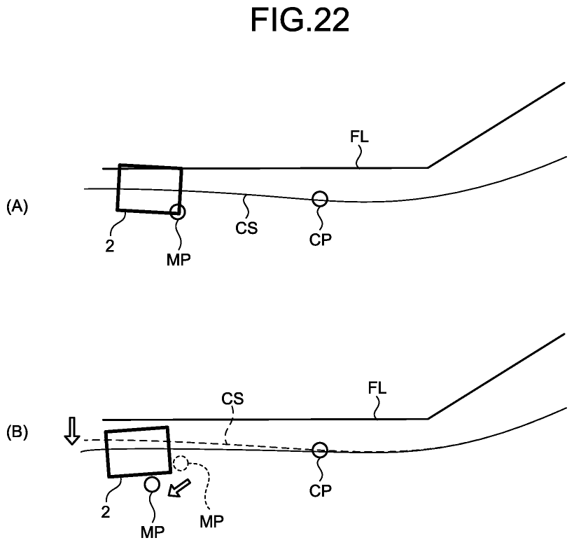

FIG. 22(A) is a view schematically illustrating a state in which part of the running course CS does not satisfy the first creation condition. As illustrated in FIG. 22(A), when the haul vehicle 2 runs along the running course CS, part of the haul vehicle 2 may come into contact with the boundary curve FL depending on the shape of the running course CS. The running course creating unit 112 can determine whether the running course CS satisfies the first creation condition, on the basis of the position data of the boundary curve FL and the outer shape data of the haul vehicle 2 running along the running course CS.

Upon determining in step S54A that the running course CS does not satisfy the first creation condition (step S54A: No), the running course creating unit 112 determines whether the first creation condition can be satisfied upon adjusting the control points MP, and then changes the running course CS by moving the control points MP upon determining that the first creation condition can be satisfied. Note that when the first creation condition is satisfied by moving the course points CP, the running course creating unit 112 may deform the running course CS by moving the course points CP. After deforming the running course CS, the running course creating unit 112 determines whether the deformed running course CS satisfies the first creation condition. The running course creating unit 112 deforms the running course CS by moving the control points MP until the first creation condition is satisfied. Upon determining that the first creation condition cannot be satisfied even by deforming the running course CS, the running course creating unit 112 determines that the running course CS cannot be created because, for example, the width of the running road HL is small, and terminates the processing of creating the running course CS.

FIG. 22(B) is a view schematically illustrating a state in which the running course CS is deformed by moving the control points MP. As illustrated in FIG. 22(B), part of the running course CS is deformed in interlocking with the movement of the control points MP by moving the control points MP. Accordingly, as illustrated in FIG. 22(B), the running course creating unit 112 can cause the haul vehicle 2 to run in the running area AR along the running course CS.

Upon determining in step S54A that the running course CS satisfies the first creation condition (step S54A: Yes), the running course creating unit 112 determines whether the running course CS satisfies the second creation condition (step S54B).

The determination whether the second creation condition is satisfied is executed for all the running courses CS. The running course creating unit 112 determines whether the minimum value of the distance between the first running course CS1 and the second running course CS2 is a distance that allows the haul vehicles 2 to pass each other. In addition, the running course creating unit 112 determines whether a region through which the haul vehicle 2 running along the first running course CS1 passes overlaps a region through which the haul vehicle 2 running along the second running course CS2 passes. If the regions overlap, the haul vehicles 2 cannot pass each other. Furthermore, the running course creating unit 112 may check a line segment representing a side surface of the haul vehicle 2 on a side near the running course CS (for example, the second running course CS2) on the opposite side to a running course (for example, the first running course SC1) on which the haul vehicle 2 runs, or the locus of an end point of the line segment.

Upon determining in step S54B that the running course CS does not satisfy the second creation condition (step S54B: No), the running course creating unit 112 corrects the positions of the control points MP so as to satisfy the second creation condition. Note that if the second creation condition is satisfied upon moving the course points CP, the running course creating unit 112 may correct the positions of the course points CP. After correcting the positions of the control points MP, the running course creating unit 112 determines whether the corrected running course CS satisfies the first creation condition. If the corrected running course CS satisfies the first creation condition, the running course creating unit 112 determines (updates) the corrected control points MP as the control points MP for creating the running course CS. Note that when the course points CP are corrected, the course points CP are also updated. If the corrected running course CS does not satisfy the first creation condition, the running course creating unit 112 attaches a flag to a region of the running course CS which does not satisfy the second creation condition (step S57C).

This flag is used to determine whether, when, for example, the haul vehicle 2 running along the running course CS1 and the haul vehicle 2 running along the running course CS2 simultaneously run near the running course CS, causing one haul vehicle 2 to stop (stand by) allows the other haul vehicle 2 to pass through.

Upon determining in step S54B that the running course CS satisfies the second creation condition (step S54B: Yes), the running course creating unit 112 determines whether the running course CS satisfies a third creation condition (step S55).

The third creation condition is a condition under which the curvature radius of the running course CS is larger than the minimum turning radius of the haul vehicle 2. The minimum turning radius of the haul vehicle 2 is the minimum turning radius through which the haul vehicle 2 can swing. The minimum turning radius of the haul vehicle 2 is the unique data of the haul vehicle 2 which is determined on the basis of the maximum steering angle of the steering device 33 of the haul vehicle 2 and the outer shape dimensions of the haul vehicle 2. The minimum turning radius of the haul vehicle 2 is known data and stored in the storage device 12. If the radius curvature of the running course CS to be created is too small relative to the minimum turning radius of the haul vehicle 2 (the curve of the running course CS is too acute), it is difficult for the haul vehicle 2 to run along the running course CS. The running course creating unit 112 creates the running course CS such that the curvature radius of the running course CS satisfies the third creation condition larger than the minimum turning radius of the haul vehicle 2.

Upon determining in step S55 that the third creation condition is not satisfied (step S55: No), the running course creating unit 112 corrects the positions of the control points MP so as to satisfy the first creation condition and the third creation condition. Note that if the third creation condition is satisfied by moving the course points CP, the running course creating unit 112 may correct the positions of the course points CP. After correcting the positions of the control points MP, the running course creating unit 112 determines whether the corrected running course CS satisfies the first creation condition. If the corrected running course CS satisfies the first creation condition, the running course creating unit 112 determines (updates) the corrected control points MP as the control points MP for creating the running course CS. Note that when the course points CP are corrected, the course points CP are also updated. If the corrected running course CS does not satisfy the first creation condition, the running course creating unit 112 attaches a flag to a region of the running course CS which does not satisfy the third creation condition (step S57D).

The region attached with this flag is handled as a region where the running course CS is created but the haul vehicle 2 may not be able to run along the running course CS.

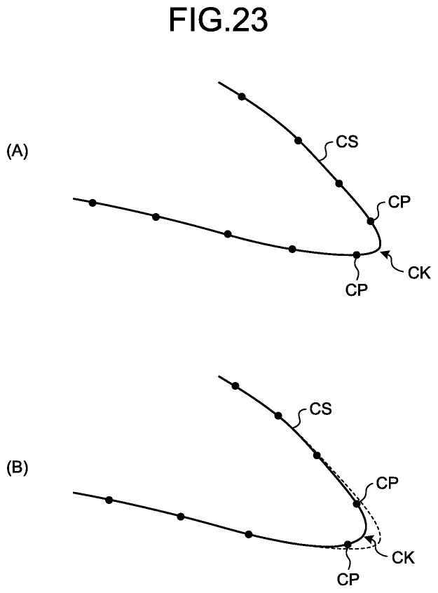

FIG. 23(A) is a view schematically illustrating a state in which the running course CS has a curve CK having a small curvature radius relative to the minimum turning radius of the haul vehicle 2. The curvature radius of the curve CK is smaller relative to the minimum turning radius of the haul vehicle 2. This makes it difficult for the haul vehicle 2 to run on the curve CK along the running course CS.

In this embodiment, the running course creating unit 112 executes offsetting and smoothing of the control points MP so as to make the curvature radius of the curve

CK satisfy the third creation condition. The running course creating unit 112 increases the curvature radius of the curve CK by moving the control points MP near the curve CK.

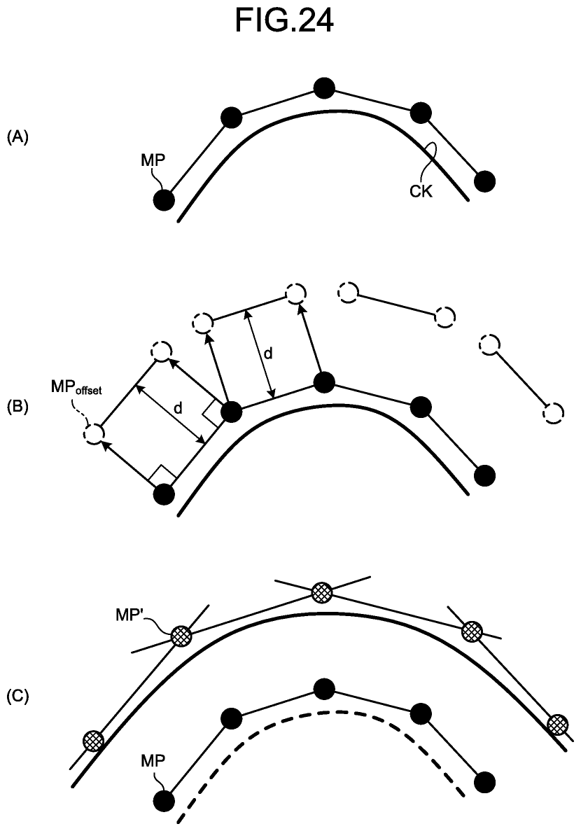

FIG. 24 is a view schematically illustrating an example of offset processing according to this embodiment. As illustrated in FIG. 24(A), the running course creating unit 112 connects, with line segments, the control points MP of the curve CK that does not satisfy the third creation condition. As illustrated in FIG. 24(B), the running course creating unit 112 then sets a control point MP_{offset} by offsetting each control point MP by a distance d in the normal direction of each of line segments connecting the control points MP. Because the number of control points MP increases as one control point MP is offset in two directions, the running course creating unit 122 connects the offset control points MP_{offset} with line segments. As illustrated in FIG. 24(C), the running course creating unit 112 then sets control points MPi′ by integrating the control points MP_{offset} with intersection points between extensions of the control points MP_{offset}. The curvature radius of a curve connecting a plurality of control points MP′ is larger than that of a curve connecting the plurality of control points MP. Note that offsetting sometimes does not lead to a smooth change in curve, smoothing processing may be executed to smooth the curve. Alternatively, an interval with a smaller curvature radius may be specified, and the running course of the specified interval may be increased by smoothing.

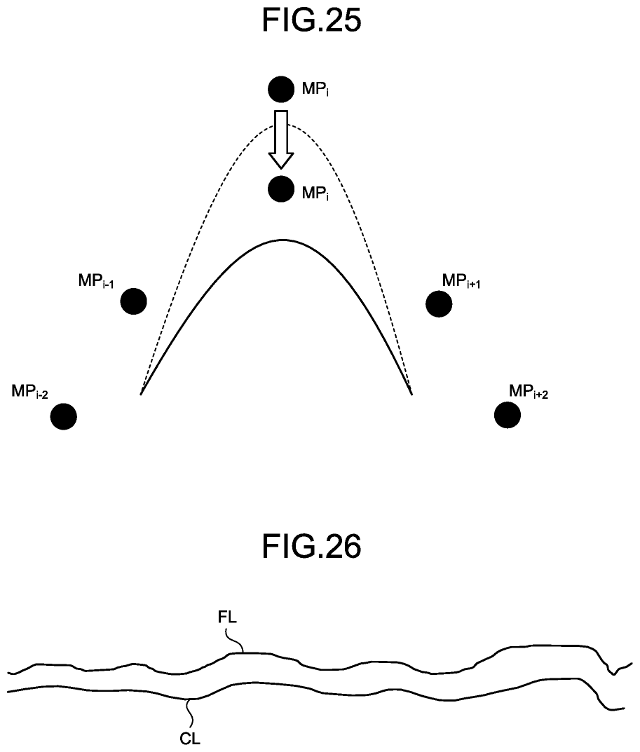

FIG. 25 is a view schematically illustrating Laplacian smoothing processing as an example of smoothing. As illustrated in FIG. 25, the running course creating unit 112 moves a control point MPᵢ near the curve CK to MPᵢ′. Setting control points MPᵢ₋₁, MPᵢ₊₁, and MPᵢ₊₂ adjacent to the control point MPᵢ can change a curvature radius of the curve CK according to equation (2).

$${MP}_{i} = \frac{{MP}_{i} + {e}^{- γ} ( {MP}_{i - 1} + {MP}_{i + 1} ) + {e}^{- 2 γ} ( {MP}_{i - 2} + {MP}_{i + 2} )}{1 + 2 {e}^{- γ} + 2 {e}^{- 2 γ}} \qquad ( 2 )$$

The running course creating unit 112 corrects the running course CS by moving the control point MP until the third creation condition is satisfied while checking that the first creation condition is satisfied. Note that when the third creation condition is satisfied by moving the course points CP, the running course creating unit 112 may move the course points CP. This creates the running course CS having the curve CK with a curvature radius larger than the minimum turning radius of the haul vehicle 2, as illustrated in FIG. 23(B).

Upon determining in step S55 that the running course CS satisfies the third creation condition (step S55: Yes), the running course creating unit 112 determines whether the running course CS satisfies the first creation condition (step S56).

Upon determining in step S56 that the first creation condition is not satisfied (step S56: No), the running course creating unit 112 corrects the running course CS by moving the control points MP (step S58). Note that if the first creation condition is satisfied by moving the course points CP, the running course creating unit 112 may move the course points CP.

Upon determining in step S56 that the first creation condition is satisfied (step S56: Yes), the running course creating unit 112 terminates the creation of the running course CS. Note that because the change amount of the running course CS under the third creation condition is small, determination on the second creation condition is not executed. However, determination on the second creation condition may be executed. Note that if the first creation condition is not satisfied, the control points MP are adjusted again.

Upon completion of the creation of the running course CS (step S50), the management apparatus 10 outputs the running course CS created by the running course creating unit 112 to the storage device 12 via the input/output interface 13. The management apparatus 10 also outputs the reference line BL created by the reference line creating unit 111 to the storage device 12 via the input/output interface 13. The running course CS and the reference line BL are stored in the storage device 12 (step S60).

In this embodiment, in order to reproduce the running course CS and the reference line BL, the control points MP and knot vectors are stored in the storage device 12. In addition, the course points CP and the reference points BP are stored in the storage device 12. Note that the reference line BL, the control points MP defining the reference points BP and the reference line BL, and knot vectors defining the reference line BL may not be stored.

When making the haul vehicle 2 run, the management apparatus 10 transmits the running course CS stored in the storage device 12 to the driving control unit 414 of the haul vehicle 2 (step S70). The driving control unit 414 creates control signals for controlling the running device 23 on the basis of the running course CS and outputs the control signals to the running device 23. The haul vehicle 2 runs in the running area AR along the running course CS on the basis of the control signal.

The running course CS is reproduced from the control points MP and knot vectors, the management apparatus 10 may extract a target point from the running course CS stored in the storage device 12 as needed, embed running conditions such as a target running velocity of the haul vehicle 2 in the target point, and transmit data representing the corresponding course point CP to the haul vehicle 2 at a necessary timing. The management apparatus 10 may also transmit control points and knot vectors to the haul vehicle 2. The haul vehicle 2 can calculate a target point and running conditions from the running course CS reproduced from the control points and the knot vectors as needed, and run on the basis of the calculated target point and running conditions.

[Effects]

As described above, according to this embodiment, the reference line BL is set on the basis of the boundary curve FL, and the running courses CS are set on both sides of the reference line BL. With this operation, the running course CS that can suppress a reduction in the operation efficiency of the haul vehicle 2 is created while man-made influences are suppressed. This suppresses a reduction in productivity in the mine as the work site.

FIG. 26 is a schematic view illustrating an example of creating the running course CS on the basis of the boundary curve FL instead of the reference line BL. Assume that the survey vehicle 5 runs along the boundary line DL of a topographic shape such as a bank or cliff, the boundary curve FL (survey line) of the running area AR for the haul vehicle 2 is set on the basis of the running locus of the survey vehicle 5, and the running course CS is created on the basis of the boundary curve FL. In this case, as illustrated in FIG. 26, the shape of the running course CS is greatly influenced by the boundary curve FL. As illustrated in FIG. 26, when the boundary curve FL has undulations, the running course CS unnecessarily meanders. If the running course CS unnecessarily meanders by being influenced by the shape of the boundary curve FL despite that the running course CS that allows the haul vehicle 2 to run linearly on the transporting road HL can be set, the running distance of the haul vehicle 2 from the exit Mo to the entrance Mi increases or the running velocity of the haul vehicle 2 running along the running course CS cannot be sufficiently increased. As a consequence, the operation efficiency of the haul vehicle 2 may decrease, and the productivity in the work site may decrease.

In this embodiment, after the reference line BL in a middle portion of the running road HL is created on the basis of the boundary curves FL on both sides of the running road HL, the running courses CS are created on both sides of the reference line BL. The reference line BL is created on the basis of one pair of the boundary curve FL1 and the boundary curve FL2 on both sides of the running road HL. In this embodiment, the reference line BL is created on the basis of distance fields to the boundary curve of the region surrounded by the pair of the boundary curve FL1 and the boundary curve FL2 on both sides of the running road HL and the distance of a route from the entrance Mi to the exit Mo. In addition, performing thinning-out processing based on line segment intersection conditions reduces the influence of the shape of the boundary curves FL1 and FL2 on the reference line BL. This also creates the running courses CS on both sides of the reference line BL with small influences of the boundary curve FL in consideration of the running characteristics of the haul vehicle 2. As a consequence, a reduction in the operation efficiency of the haul vehicle 2 running along the running course CS is suppressed.

In this embodiment, the reference line creating unit 111 can also create the reference line BL so as to increase the distance from the boundary curve FL and reduce the length of the reference line BL connecting the start point and the end point of the running area AR. This sets the reference line BL on a middle portion of the running road HL in the widthwise direction and prevents the reference line BL from unnecessarily meandering.

In this embodiment, creating the reference line BL allows the running course creating unit 112 to smoothly create the running course CS1 and the running course CS2 that make the haul vehicle 2 run in opposite directions in the running area AR. In the embodiment, the running course CS1 and the running course CS2 that allow the haul vehicles 2 pass each other are automatically created, and hence, for example, fine adjustment of the running courses CS by the manual operation of a worker can be omitted. When workers manually execute fine adjustment, the times required for fine adjustment and the qualities of the running courses CS after fine adjustment differ depending on the skills of the workers. In this embodiment, it is possible to automatically create the running courses CS1 and CS2 that allow the haul vehicles 2 to pass each other without much man-made influences.

Note that in the above embodiment, the running courses CS may be set on both sides of a first portion of the reference line BL, and the running course CS may be set on only one side of a second portion of the reference line BL which is different from the first portion. For example, like a narrow portion of the running road HL, the running road HL sometimes has a portion where the haul vehicles 2 cannot pass each other. In such a portion, the running course CS may be set only one side of the reference line BL. In addition, the reference line BL itself may be regarded as the running course CS.

Note that in the above embodiment, the controller 40 of the haul vehicle 2 may have at least the function of the reference line creating unit 111 and the function of the running course creating unit 112. In addition, for example, one of the reference line creating unit 111 and the running course creating unit 112 is provided in the management apparatus 10, and the other is provided in the controller 40.

Note that in the above embodiment, the boundary curve FL, the reference line BL, and the course CS are defined in the local coordinate system, together with the boundary curve points FP, the reference points BP, the course points CP, and the like which constitute the boundary curve FL, the reference line BL, and the running course CS. However, they may be defined in the global coordinate system. Various types of processing may be executed on the basis of the global coordinate system.

Note that in the above embodiment, the running courses CS are set on both sides of the reference line BL. The running course CS may be set on one side of the reference line BL.

### REFERENCE SIGNS LIST

1 CONTROL SYSTEM

2 HAUL VEHICLE

3 LOADING EQUIPMENT

4 CRUSHING MACHINE

5 SURVEY VEHICLE

6 POSITION DETECTOR

8 CONTROL FACILITY

9 COMMUNICATION SYSTEM

10 MANAGEMENT APPARATUS

11 ARITHMETIC PROCESSOR

12 STORAGE DEVICE

13 INPUT/OUTPUT INTERFACE

14 WIRELESS COMMUNICATION DEVICE

15 INPUT DEVICE

16 OUTPUT DEVICE

21 VEHICLE FRAME

22 DUMP BODY

23 RUNNING DEVICE

24 TIRE

25 WHEEL

25F FRONT WHEEL

25R REAR WHEEL

26 REAR AXLE

27 AXLE SHAFT

31 DRIVING DEVICE

32 BRAKING DEVICE

33 STEERING DEVICE

34 POSITION DETECTOR

35 DETECTOR

35A STEERING ANGLE SENSOR

35B AZIMUTH ANGLE SENSOR

40 CONTROLLER

41 ARITHMETIC PROCESSOR

42 STORAGE DEVICE

43 INPUT/OUTPUT INTERFACE

44 WIRELESS COMMUNICATION DEVICE

111 REFERENCE LINE CREATING UNIT

112 RUNNING COURSE CREATING UNIT

411 RUNNING COURSE ACQUISITION UNIT

412 POSITION DATA ACQUISITION UNIT

413 DETECTION DATA ACQUISITION UNIT

414 DRIVING CONTROL UNIT

AR RUNNING AREA

AX ROTATION AXIS

BI IMAGINARY LINE

BL REFERENCE LINE

BP REFERENCE POINT

CP COURSE POINT

CS RUNNING COURSE

CS1 FIRST RUNNING COURSE

CS2 SECOND RUNNING COURSE

D DISTANCE

DL BOUNDARY LINE

DPA UNLOAD SITE

ER FORBIDDEN AREA

FL BOUNDARY CURVE

FP BOUNDARY CURVE POINT

HL RUNNING ROAD

IS INTERSECTION POINT

LPA LOAD SITE

MP CONTROL POINT

PA WORK SITE

SL SURVEY LINE

1. A haul vehicle control system comprising:
a reference line creating unit configured to create, based on a boundary curve of a running area in a work site where a haul vehicle is configured to run, a reference line set so as to connect a start point and an end point of the running area; and
a running course creating unit configured to create a running course for the haul vehicle which is set in the running area, based on the reference line.

2. The haul vehicle control system according to claim 1, wherein
the running course creating unit sets the running courses on both sides of at least part of the reference line.

3. The haul vehicle control system according to claim 1, wherein
the reference line creating unit creates the reference line such that a distance from the boundary curve is long, and a length of the reference line connecting the start point and the end point of the running area is short.

4. The haul vehicle control system according to claim 1, wherein
the reference line creating unit creates the reference line based on start point data and end point data of the haul vehicle configured to run in the running area.

5. The haul vehicle control system according to claim 1, wherein
the reference line creating unit creates the reference line so as to increase a turning radius of the haul vehicle and reduce a steering change amount of the haul vehicle per unit time.

6. The haul vehicle control system according to claim 1, wherein
the reference line creating unit determines reference points by selecting some candidate points from a plurality of candidate points calculated based on the boundary curve, and creates the reference line by interpolating the determined reference points.

7. The haul vehicle control system according to claim 1, wherein
the boundary curve includes at least one of a boundary line of a topographic shape of the work site, a survey line set based on a running locus of a survey vehicle that has run along the boundary line, measurement data of the topographic shape which is measured by a flight vehicle that has flied along the boundary line, and design data of the boundary line.

8. The haul vehicle control system according to claim 1, wherein
the running course creating unit creates the running course based on position data of the boundary curve and outer shape data of the haul vehicle so as to allow the haul vehicle to run on in the running area.

9. The haul vehicle control system according to claim 8, wherein
the running course creating unit creates the running course based on outer shape data of the haul vehicle so as to allow the haul vehicle running on one side of the reference line and the haul vehicle running on the other side of the reference line to travel in opposite directions.

10. The haul vehicle control system according to claim 8, wherein
the running course creating unit creates the running course so as to make a curvature radius of the running course larger than a minimum turning radius of the haul vehicle.

11. The haul vehicle control system according to claim 1, wherein
the boundary curve includes a first boundary curve and a second boundary curve facing the first boundary curve,
the running area includes a running road between the first boundary curve and the second boundary curve, and
the running course includes, in the running road, a first running course set between the reference line and the first boundary curve and a second running course set between the reference line and the second boundary curve.

12. A haul vehicle control method comprising:
creating, based on a boundary curve of a running area in a work site where a haul vehicle is configured to run, a reference line set so as to connect a start point and an end point of the running area; and
creating a running course for the haul vehicle which is set in the running area based on the reference line.
